(19) United States
(12) Patent Application Publication
(10) Pub. No.: US 2014/0075240 A1
(43) Pub. Date: Mar. 13, 2014

(54) STORAGE APPARATUS, COMPUTER PRODUCT, AND STORAGE CONTROL METHOD

(71) Applicant: FUJITSU LIMITED, Kawasaki-shi (JP)

(72) Inventors: Chikashi MAEDA, Kawasaki (JP); Hidejirou DAIKOKUYA, Kawasaki (JP); Kazuhiko IKEUCHI, Kawasaki (JP); Takeshi WATANABE, Kawasaki (JP); Norihide KUBOTA, Kawasaki (JP); Atsushi IGASHIRA, Yokohama (JP); Kenji KOBAYASHI, Kawasaki (JP); Ryota TSUKAHARA, Kawasaki (JP)

(73) Assignee: FUJITSU LIMITED, Kawasaki-shi (JP)

(21) Appl. No.: 13/953,819

(22) Filed: Jul. 30, 2013

(30) Foreign Application Priority Data
Sep. 12, 2012 (JP) 2012-201005

(51) Int. Cl. G06F 11/20

(52) U.S. Cl. CPC G06F 11/2069
USPC 714/6.23

(57) ABSTRACT

A storage controller detects a failure of any one of storage units making up a RAID group. The storage controller incorporates plural hot spares HS into the RAID group, as substitute storage units for the detected failed storage. The storage controller restores the memory contents of the failed storage unit onto each of the hot spares incorporated into the RAID group. Upon detecting replacement of the failed storage unit in the RAID group, the storage controller incorporates into the RAID group, a replacement storage unit that has replaced the failed storage unit.

### CROSS REFERENCE TO RELATED APPLICATIONS

This application is based upon and claims the benefit of priority of the prior Japanese Patent Application No. 2012-201005, filed on Sep. 12, 2012, the entire contents of which are incorporated herein by reference.

### FIELD

The embodiments discussed herein are related to a storage apparatus, computer product, and storage control method.

### BACKGROUND

When a disk drive making up a redundant array of independent disks (RAID) fails, a rebuilding process may be executed to restore the redundancy of the RAID group. The rebuilding process is a process of restoring data of the failed disk using a substitute disk called hot spare.

After the completion of the rebuilding process, a copy back process may be executed restore the configuration of the RAID group to the original configuration before the disk failure. The copy back process is a process of copying data on the hot spare to a new disk that has replaced the failed disk in the RAID group whose redundancy has been restored using the hot spare.

According to one related prior art, when a data disk of the RAID group fails, disk management is modified so that the physical location of a spare disk to which data is copied by a collection copy process is switched for the physical location of the data disk that failed. According to another such technique, when a disk array configuration is changed to a configuration using a spare disk on which data stored in a failed disk is restored and then the failed disk is replaced with a functional disk, data stored in the spare disk is restored onto the replaced disk, changing the disk array configuration again to a configuration using the replaced disk. According to still another technique, when a live machine fails, a spare machine reads out take-over information from a shared disk device, takes over a process performed by the live machine that failed, and copies the data contents of the shared disk device to a built-in disk device of the spare machine. For examples, refer to Japanese Laid-Open Patent Publication Nos. 2007-087039, H11-184643, and H06-175788.

The conventional techniques pose a problem that an increase in the capacity of storage leads to an increase in a processing time required for a copy back process for restoring the configuration of the RAID group to the original configuration before the occurrence of a storage failure.

### SUMMARY

According to an aspect of an embodiment, a storage apparatus includes plural storage units belonging to a redundantly configured storage unit group; a first storage unit and a second storage unit independent of the storage unit group; a configuration control unit that incorporates at least any one among the first storage unit and the second storage unit into the storage unit group or separates at least any one among the first storage unit and the second storage unit from the storage unit group; and a restoring unit that when a storage unit in the storage unit group fails, restores memory contents of the failed storage unit onto the first storage unit and second storage unit incorporated into the storage unit group by the configuration control unit, based on memory contents of the storage units other than the failed storage unit and belonging to the storage unit group. The configuration control unit without separating the second storage unit, separates the first storage unit from the storage unit group after the restoring unit restores the memory contents, and when the failed storage unit has been replaced with the first storage unit, incorporates the first storage unit into the storage unit group, as a replacement storage unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1 and 2 are flowcharts of an example of a storage control method according to embodiments;

FIG. 3 is a configuration example of a system 300 according to the embodiments;

FIG. 4 is a block diagram of a hardware configuration of a storage controller 101;

FIG. 5 is an explanatory diagram of an example of a RAID group G;

FIG. 6 is an explanatory diagram (1) of the memory contents of a RAID management table 600;

FIG. 7 is an explanatory diagram (1) of the memory contents of a disk management table 700;

FIG. 8 is a block diagram of a functional configuration of the storage controller 101;

FIG. 9 is an explanatory diagram of an example of the memory contents of a bitmap table 900;

FIG. 10 is an explanatory diagram of an example of a transition of the state of the RAID group G;

FIG. 11 is an explanatory diagram of an example of a selection policy 1100;

FIG. 12 is an explanatory diagram of an example of creating a virtual disk;

FIG. 13 is an explanatory diagram (2) of an example of the memory contents of the RAID management table 600;

FIGS. 14A, 14B, 14C, AND 14D are explanatory diagrams (2) of an example of the memory contents of the disk management table 700;

FIG. 15 is a flowchart of an example of a rebuilding procedure by the storage controller 101;

FIGS. 16, 17, 18, 19, and 20 are flowcharts of an example of a specific procedure of a hot spare retrieving process;

FIG. 21 is a flowchart of an example of a specific procedure of a retrieving process A;

FIG. 22 is a flowchart of an example of a procedure of a retrieving process B;

FIG. 23 is a flowchart of an example of a procedure of an assigning process; and

FIGS. 24, 25, 26, and 27 are flowcharts of an example of a RAID group configuration rebuilding procedure by the storage controller 101.

### DESCRIPTION OF EMBODIMENTS

Preferred embodiments will be explained with reference to the accompanying drawings.

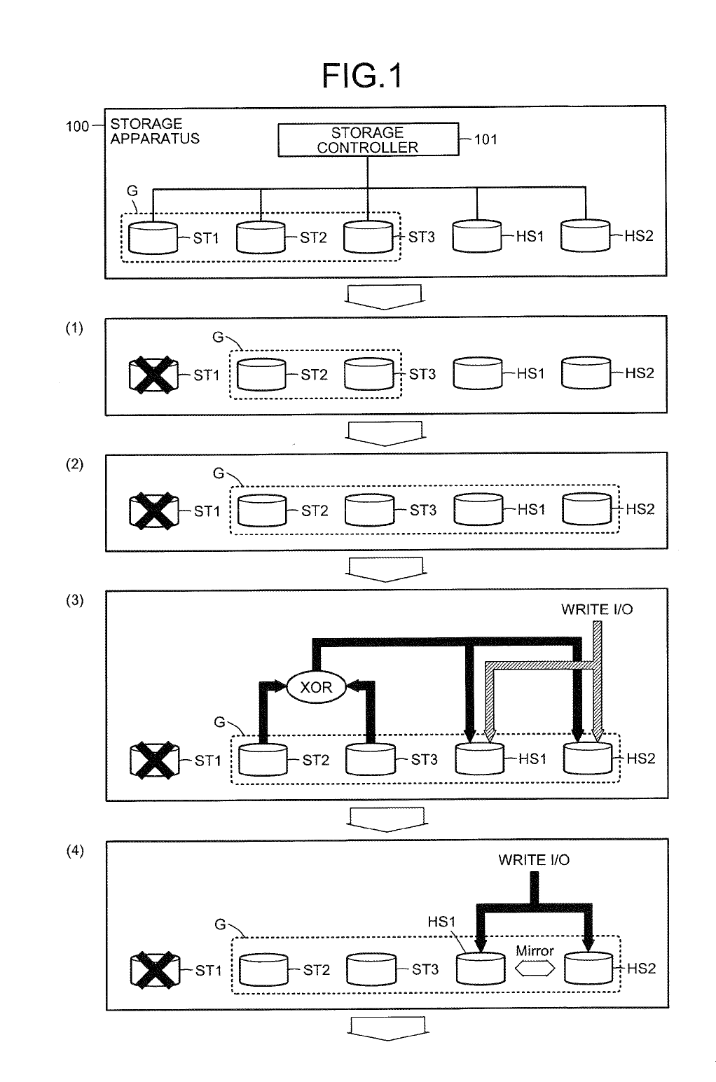

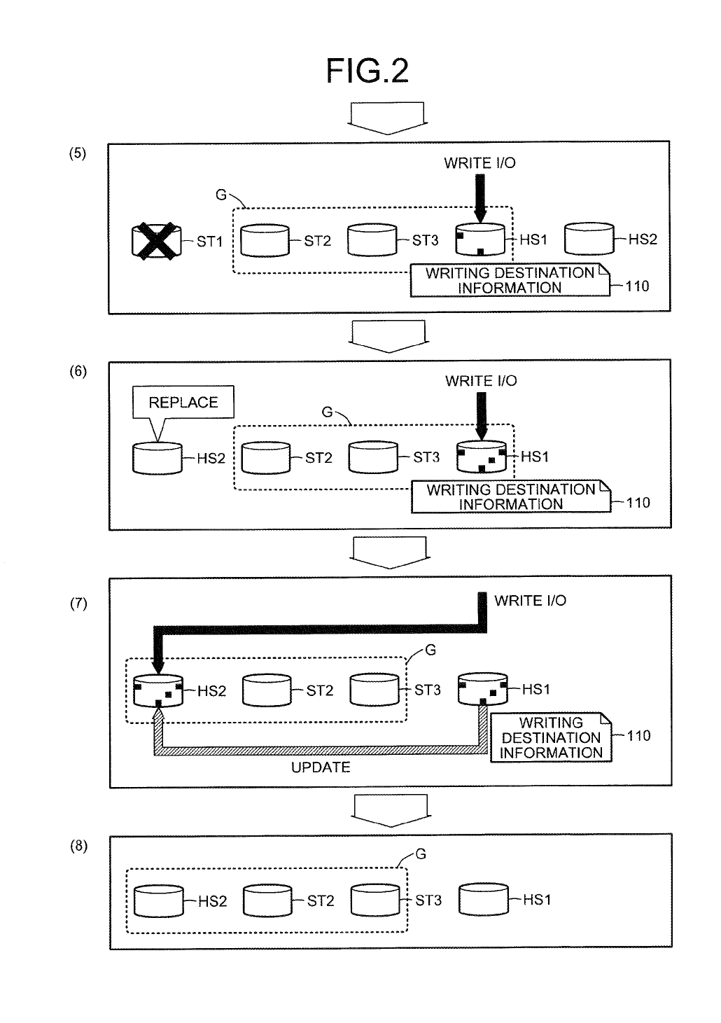

FIGS. 1 and 2 are flowcharts of an example of a storage control method according to the embodiments. In FIG. 1, a storage apparatus 100 represents a storage system that may ensure data redundancy through a redundancy technique, such as RAID. The storage apparatus 100 includes a storage controller 101 and multiple storage units (storage units ST1 to ST3 and hot spares HS1 and HS2 in FIG. 1).

The storage controller 101 is a computer that controls the reading and writing of data with respect to the storage units. The storage controller 101 is, for example, a RAID controller, and the storage apparatus 100 may be equipped with the storage controllers 101 in plural. The storage units are storage devices that store data therein. The storage units include memory media, such as a hard disk, an optical disk, flash memory, and a magnetic tape.

The storage controller 101 may form a redundantly configured storage unit group (hereinafter “RAID group G”). The RAID group G is a single logical storage entity that is formed by combining together two or more storage units to ensure data redundancy.

In FIG. 1, the storage units ST1 to ST3 are combined together to make up the RAID group G having a RAID level of 5. A hot spare HS (hot spares HS1 and HS2 in FIG. 1) is a storage unit that is used as a substitute storage unit for a failed storage unit when any one of the storage units of the RAID group G fails.

In the following explanation, an arbitrary storage unit in the RAID group G may be referred to as “storage unit ST”.

When any one of storage units ST in the RAID group G fails, a rebuilding process for restoring the redundancy of the RAID group G is executed. The rebuilding process is a process for restoring data stored in the failed storage unit in the RAID group G. For example, rebuilding process is the process of incorporating a storage unit serving as a hot spare HS into the RAID group G to allocate a memory area for the hot spare HS and rebuilding data stored in the failed storage unit onto the hot spare SH.

After the completion of the rebuilding process executed consequent to a storage unit failure, if the storage apparatus continues to be operated using the hot spare, the physical locations of the storage units ST making up the RAID group G may become too complicated to grasp. For example, when the rebuilding process using the hot spare HS is executed and the configuration of the RAID group G is changed each time a storage unit failure occurs, grasping the physical locations of the storage units ST become difficult.

Depending on the physical location of the hot spare HS used for data rebuilding, storage units ST of the RAID group G may be located in the same enclosure or connected to the same back end loop in a biased configuration. Continued operation of the storage apparatus in this state is undesirable in terms of performance and safety. An enclosure is a housing in which storage units are housed. The storage apparatus 100 is provided with, for example, one or more enclosures. A back end loop is a path connecting the storage controller 101 to storage units.

Following the completion of the rebuilding process, a copy back process is executed for restoring the configuration of the RAID group G to the original configuration before the failure of a storage unit ST. The copy back process is a process of copying data on the hot spare HS to a spare disk for the RAID group G, for which the redundancy has been restored using the hot spare HS. A spare disk is a new storage unit used by a worker, such as customer engineer (CE), to replace the failed storage unit with the new storage.

As the storage capacity increases, the processing time required for the copy back process increases. For example, a disk with a storage capacity of 1 [TB] and a rotating speed of 7200 [rpm] may take 70 hours or more to complete the copy back process. In addition, access of storage units for the copy back process creates access load that reduces response performance with respect to input/output (I/O) requests from a host. For example, during the copy back process, which consumes 70 hours or more to complete, response performance with respect to input/output (I/O) requests from the host may drop by about 20%.

According to the embodiments, the storage controller 101 restores data stored in the failed storage unit onto two hot spares HS, and uses one hot spare HS as a storage for processing a new I/O request while replacing the failed storage unit with the other hot spare HS to incorporate it into the RAID group G. This reduces a processing time required for a restoration process for restoring the configuration of the RAID group G to the original configuration before the occurrence of a failure of a storage unit ST.

An example of a storage controlling process by the storage controller 101 according to the embodiments will hereinafter be described with reference to FIGS. 1 and 2.

(1) The storage apparatus 101 detects failure of any one of the storage units ST of the RAID group G. For example, when the reading and/or writing of data with respect to a storage unit ST doesnot be performed properly, the storage controller 101 detects a failure of the storage unit ST. In the example of FIG. 1, the storage controller 101 detects a failure of the storage unit ST1 of the RAID group G.

Upon detecting a failure of the storage unit ST1, the storage controller 101 may send a failure notice indicating the failure of the storage unit ST1 in the RAID group G to a computer used by a worker, such as a CE. Through this notice, the worker, such as a CE, may determine that the storage unit ST1 in the RAID group G has failed.

(2) The storage controller 101 incorporates multiple hot spares HS into the RAID group G, as substitute storage units for the detected failed storage. As a result, the memory area of the hot spares HS is assigned to a memory area for data rebuilding, which means that the hot spares HS are assigned to the RAID group G, as members (disks) of the RAID group G. Each hot spare HS incorporated into the RAID group G is a storage unit having a memory capacity greater than or equal to the memory capacity of the failed storage unit.

In FIG. 1, the storage controller 101 incorporates the hot spares HS1 and HS2 into the RAID group G, as substitute storage units for the failed storage unit ST1 of the RAID group G. As a result, the memory area of the hot spares HS1 and HS2 is assigned to the memory area for data rebuilding.

(3) The storage controller 101 restores the memory contents of the failed storage unit onto each of the hot spares incorporated into the RAID group G. For example, the storage controller 101 restores the memory contents of the storage unit ST1 onto each of the hot spares HS1 and HS2, based on the memory contents of the storage units ST2 and ST3 that are storage units other than the storage unit ST1 of the RAID group G.

As depicted in FIG. 1, the storage controller 101 calculates the Exclusive-OR (XOR) of data stored in the storage unit ST2 and data stored in the storage unit ST3 and restores data stored in the storage unit ST1. The storage controller 101 then writes the restored data stored in the storage unit ST1 to each of the hot spares HS1 and HS2 incorporated into the RAID group G.

In other words, the storage controller 101 executes a rebuilding process of restoring the memory contents of the failed storage unit (storage unit ST1) onto the hot spares HS1 and HS2 incorporated into the RAID group G. Through this process, the redundancy of the RAID group G may be restored using the hot spares HS1 and HS2.

If a write I/O request for the storage unit ST1 is made during the rebuilding process, the storage controller 101 writes writing data to each of the hot spares HS1 and HS2. Writing data is data to be written according to the write I/O request. In this manner, the redundancy of the RAID group G may be restored without task suspension, using the RAID group G.

(4) Upon completing the rebuilding process on the hot spares HS, the storage controller 101 outputs a rebuilding process completion notice. For example, the storage controller 101 may send the completion notice indicating the completion of the rebuilding process for the RAID group G, to the computer used by the worker, such as a CE. This allows the worker, such as a CE, to know that the rebuilding process for the RAID group G has been completed.

For example, when the rebuilding process on the hot spares HS1 and HS2 is completed, the memory contents of the failed storage unit ST1 are restored onto the hot spares HS1 and HS2. As a result, the memory contents of the hot spare HS1 become equivalent to the memory contents of the hot spare HS2. After the completion of the rebuilding process, if a write I/O request for the storage unit ST1 is made, the storage controller 101 writes writing data to each of the hot spares HS1 and HS2 as during the rebuilding process.

(5) Upon receiving a replacement work starting notice, the storage controller 101 separates any one among the multiple hot spares HS incorporated into the RAID group G from the RAID group G to put the hot spare in a state enabling separation from the storage apparatus 100. The replacement work starting notice is a notice of the start of work of replacing the failed storage unit of the RAID group G, and is sent, for example, from the computer used by the worker, such as a CE, to the storage controller 101.

As depicted in FIG. 2, upon receiving the replacement work starting notice, the storage controller 101 separates the hot spare HS2 incorporated into the RAID group G from the RAID group G to put the hot spare HS2 in a state enabling separation from the storage apparatus 100.

After separation of the hot spare HS2 from the RAID group G, if a write I/O request for the storage unit ST1 is made, the storage controller 101 writes writing data to the hot spare HS1. In FIG. 2, ▪ in a figure representing a storage unit ST denotes a memory area that within the memory area of the storage unit ST, is a writing destination to which writing data is to be written.

The storage controller 101 retains writing destination information 110 for identifying the writing destination of the writing data that has been written into the hot spare HS1. For example, the writing destination information 110 is address information for identifying within memory area of the hot spare HS1, the memory area of the writing destination to which the writing data has been written.

When the hot spare HS2 becomes ready for separation from the storage apparatus 100, the worker, such as a CE, separates the hot spare HS2 from the storage apparatus 100 and replaces the failed storage unit ST1 of the RAID group G with the hot spare HS2.

(6) The storage controller 101 detects replacement of the failed storage unit ST of the RAID group G with a different storage unit. In the example of FIG. 2, the storage controller 101 detects replacement of the failed storage unit ST1 of the RAID group G with the replacement storage unit.

(7) Upon detecting replacement of the failed storage unit ST of the RAID group G with the replacement storage unit, the storage controller 101 incorporates into the RAID group G, the replacement storage unit that has replaced the failed storage unit. In the example of FIG. 2, the storage controller 101 incorporates into the RAID group G, the hot spare HS2 that has replaced the storage unit ST1.

Upon completing incorporation of the hot spare HS2 into the RAID group G, the storage controller 101 refers to the writing information 110 and writes the writing data stored in the hot spare HS1 to the hot spare HS2 (“update” in FIG. 2).

In this manner, the writing data written to the hot spare HS1 during the period between the separation of the hot spare HS2 from the RAID group G and the incorporation of the hot spare HS2 into the RAID group G may be copied to the hot spare HS2 as update data.

(8) Upon completing the writing of the writing data to the replacement storage unit, the storage controller 101 releases the incorporated hot spare HS from the RAID group G. In the example of FIG. 2, the storage controller 101 releases the incorporated hot spare HS1 from the RAID group G upon completing the writing of the writing data to the hot spare HS2. In this manner, the configuration of the RAID group G may be restored to the original configuration before the failure of the storage unit ST1.

In this manner, when a storage unit ST of the RAID group G fails, the storage controller 101 incorporates two hot spares HS into the RAID group G and restores data stored in the failed storage unit onto the two hot spares HS. The storage controller 101 uses one of the hot spares HS incorporated in the RAID group G as a hot spare for processing a new I/O request, and replaces the failed storage unit with the other hot spare HS to incorporate the replacing hot spare HS into the RAID group G. In this manner, when any one of the storage units ST of the RAID group G fails, the redundancy of the RAID group G is restored, and the configuration of the RAID group G is restored to the original configuration before the failure of the storage unit ST.

The storage controller 101 updates the data contents of a memory area to which a write I/O request has been made during failed storage replacement work by copying data from the hot spare HS to the replacement storage unit as update data, thereby enabling continuation of a task using the RAID group G during the failed storage unit replacement work. Because data updating is performed only on the memory area to which the write I/O request has been made during the failed storage unit replacement work, the processing time required for the restoration process of restoring the configuration of the RAID group G to the original configuration before the failure of the storage unit ST may be reduced, compared to the conventional copy back process.

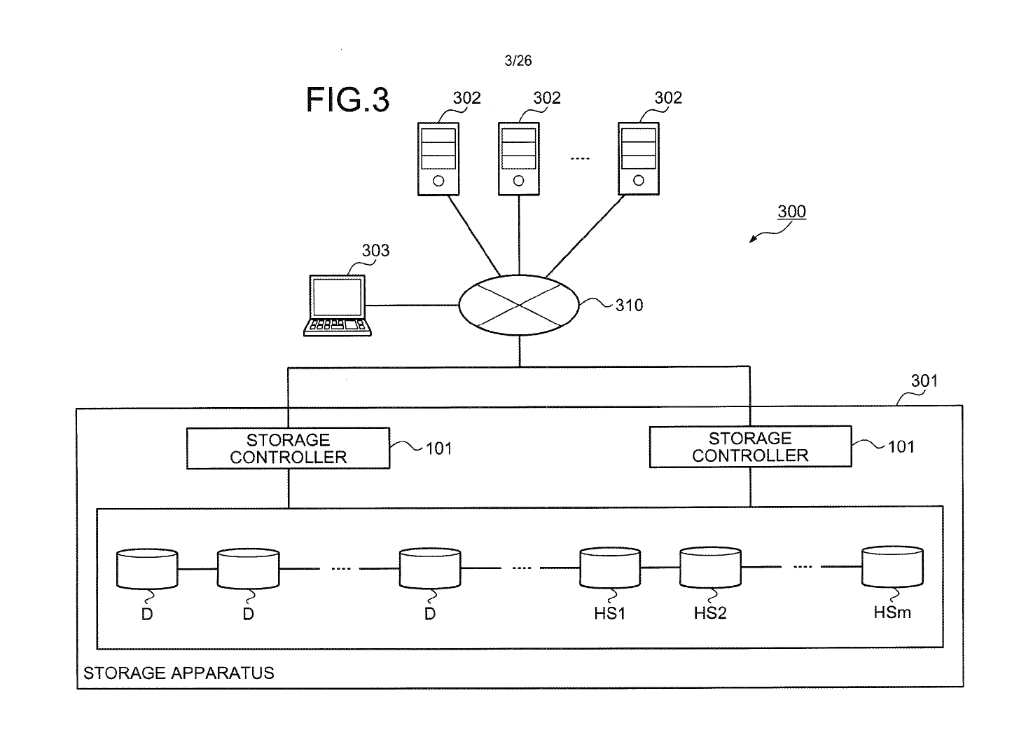

FIG. 3 is a configuration example of a system 300 according to the embodiments. In FIG. 3, the system 300 includes a storage apparatus 301, multiple hosts 302, and a worker terminal 303. In the system 300, the storage apparatus 301, the hosts 302, and the worker terminal 303 are interconnected via a wired or radio network 310. The network 310 is provided as, for example, the Internet, a local area network (LAN), a wide area network (WAN), etc.

The storage apparatus 301 is a computer that may ensure data redundancy, and is equivalent to the storage apparatus 100 of FIG. 1. The storage apparatus 301 includes the storage controller 101 (two storage controllers 101 in FIG. 3), multiple disks D, and hot spares HS1 to HSm.

The disks D are storage devices that store data therein, and are equivalent to, for example, the storage units ST1 to ST3 of FIG. 1. The hot spares HS1 to HSm are storage devices used as substitute disks for a failed disk, and are equivalent to, for example, the hot spares HS1 and HS2 of FIG. 1.

Each of the disks D and the hot spares HS1 to HSm includes, for example, a hard disk and a disk drive that controls the reading and writing of data with respect to the hard disk. All of the memory capacities of the disks D and hot spares HS1 to HSm may be the same or some of the memory capacities may be different from each other.

Each host 302 is a computer that requests the storage apparatus 301 for the reading and writing of data. For example, the host 302 is a personal computer (PC) or server operated by a user who uses the system 300.

The worker terminal 303 is a computer used by a worker, such as a CE. The worker, such as a CE, uses the worker terminal 303 to input various instructions to the storage controller 101 and to receive various notices from the storage controller 101. The worker terminal 303 is, for example, a notebook PC, desktop PC, etc., used by the worker, such as a CE.

In the following explanation, an arbitrary RAID group formed by combining together a group of disks D included in the storage apparatus 301 may be referred to as “RAID group G”, and the group of disks making up the RAID group G may be referred to as “disks D1 to Dn”. An arbitrary disk among the disks D1 to Dn may be referred to as “disk Di” (i=1, 2, . . . , n). An arbitrary hot spare among the hot spares HS1 to HSm may be referred to as “hot spare HSj” (j=1, 2, . . . , m).

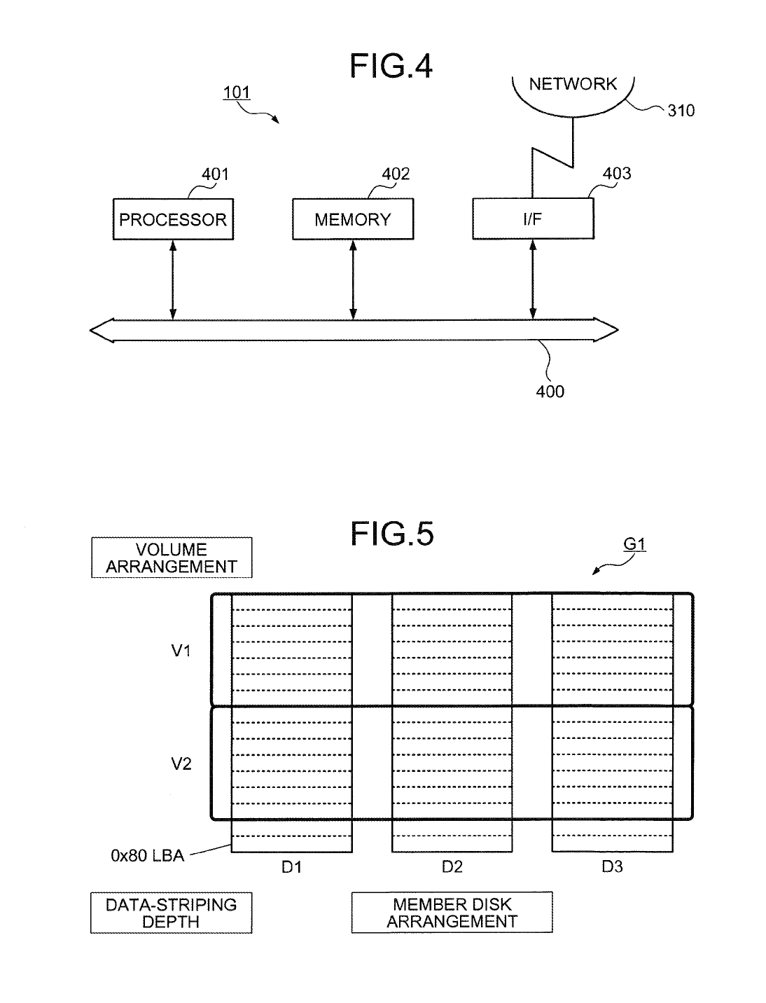

FIG. 4 is a block diagram of a hardware configuration of the storage controller 101. In FIG. 4, the storage controller 101 has a processor 401, memory 402, and an interface (I/F) 403, respectively connected through a bus 400.

The processor 401 supervises overall control over the storage controller 101. The memory 402 has, for example, read-only memory (ROM), random-access memory (RAM), and flash ROM.

For example, the flash ROM stores programs, such as OS and firmware; the ROM stores application programs; and the RAM is used as a work area of the processor 401. A program stored in the memory 402 is loaded onto the processor 401, where the program causes the processor 401 to execute a coded process.

The I/F 403 controls the input and output of data with respect to a different computer. For example, the I/F 403 is connected to the network 310 through a communication line and is connected to another computer (e.g., the storage apparatus 301, host 302, disk D, or hot spare HS of FIG. 3). Hence, the I/F 403 serves as an interface between the network 310 and the storage controller 101, and controls the input and output of data with respect to another computer.

The storage apparatus 301, the host 302, and the worker terminal 303 of FIG. 3 may be realized by adopting the same hardware configuration as that of the storage controller 101. The host 302 and the worker terminal 303 may further have a display, keyboard, etc., in addition to the component units described above.

An example of the RAID group G will be described. In the example, the RAID group G is a single logical storage entity formed by combining together two or more disks D of the storage apparatus 301.

FIG. 5 is an explanatory diagram of an example of the RAID group G. In FIG. 5, a RAID group G1 is formed by disks D1 to D3. On the RAID group G1, logical volumes V1 and V2 are formed by combining together memory areas of the disks D1 to D3.

The RAID level of the RAID group G1 is defined as RAID 5. The disk-striping depth of the RAID group G1 is defined as 0×80 logical block addressing (LBA).

The memory contents of a RAID management table 600 used by the storage controller 101 will be described by taking the RAID group G1 of FIG. 5 as an example. The RAID management table 600 is made for each RAID group G, and is stored in, for example, the memory 402 depicted in FIG. 4.

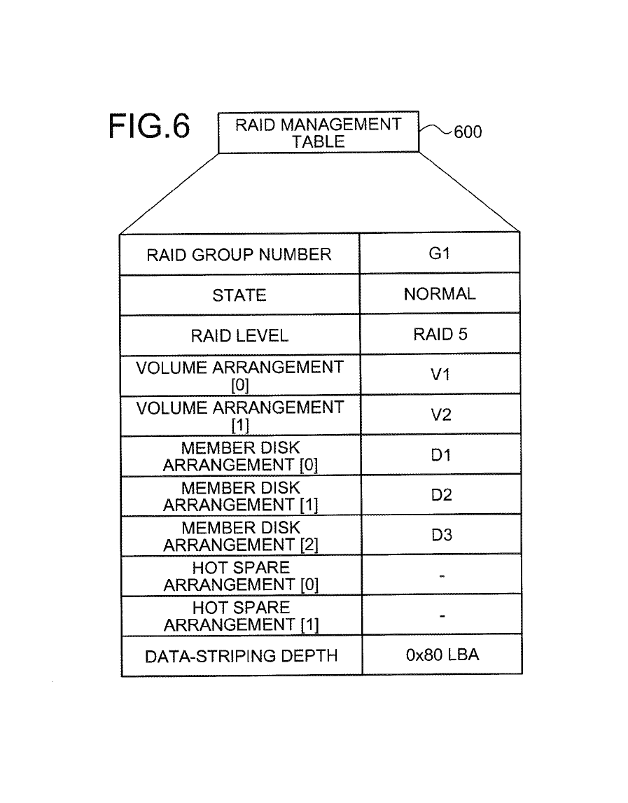

FIG. 6 is an explanatory diagram (1) of the memory contents of the RAID management table 600. In FIG. 6, the RAID management table 600 has information including the RAID group number, state, RAID level, volume arrangement, member disk arrangement, hot spare arrangement, and disk-striping depth.

The RAID group number indicates identification information of a RAID group G. State indicates the state of the RAID group G. The RAID group G has various states, such as Normal, Duplicative Rebuilding, Duplicative Spare, in Use, HS Transfer in Progress (Redundant), and Data Updating Copy in Progress (Redundant). RAID level indicates the RAID level of the RAID group G. The RAID level of the RAID group G is one among multiple RAID levels, such as RAID 1, RAID 2, RAID 3, RAID 4, RAID 5, and RAID 6.

Volume arrangement indicates the arrangement of logical volumes made on the RAID group G. For example, volume arrangement [0] indicates the first logical volume made on the RAID group G. Member disk arrangement indicates the arrangement of disks Di belonging to the RAID group G. For example, member disk arrangement [0] indicates the disk number of the first disk Di belonging to the RAID group G.

Hot spare arrangement indicates the arrangement of hot spares HS incorporated into the RAID group G. For example, hot spare arrangement [0] indicates the disk number of the first hot spare HS incorporated into the RAID group G. Disk-striping depth indicates the depth of disk-striping performed in the RAID group G.

The memory contents of a disk management table 700 used by the storage controller 101 will be described by taking a disk D1 in the RAID group G1 as an example. The disk management table 700 is made for, for example, respectively for the disks D, hot spares HS, and virtual disks included in the storage apparatus 301, and is stored in, for example, the memory 402 of FIG. 4.

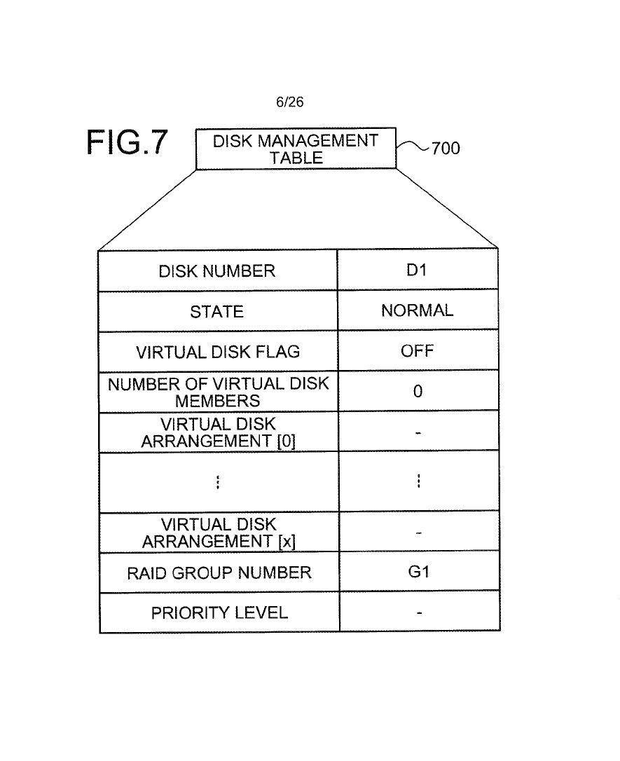

FIG. 7 is an explanatory diagram (1) of the memory contents of the disk management table 700. In FIG. 7, the disk management table 700 has information including the disk number, state, a virtual disk flag, the number of virtual disk members, virtual disk arrangement, the RAID group number, and a priority level.

The disk number indicates identification information of a disk Di. State indicates the state of the disk Di. The disk Di has various states, such as normal and failure. The virtual disk flag is a flag indicating whether the disk Di is operating as a virtual disk. The virtual disk flag is set to “ON” when the disk Di is operating as a virtual disk, and is set to “OFF” when the disk Di is not operating as a virtual disk.

The number of virtual disk members indicates the number of actual disks making up the virtual disk. If the disk Di is not operating as a virtual disk, the number of virtual disk members is set to “0”. The virtual disk arrangement is the arrangement of actual disks making up a virtual disk. For example, a virtual disk arrangement [0] indicates the first actual disk making up the virtual disk. If the disk Di is not operating as a virtual disk, virtual disk arrangements [0] to [x] are each set to “-(null)”.

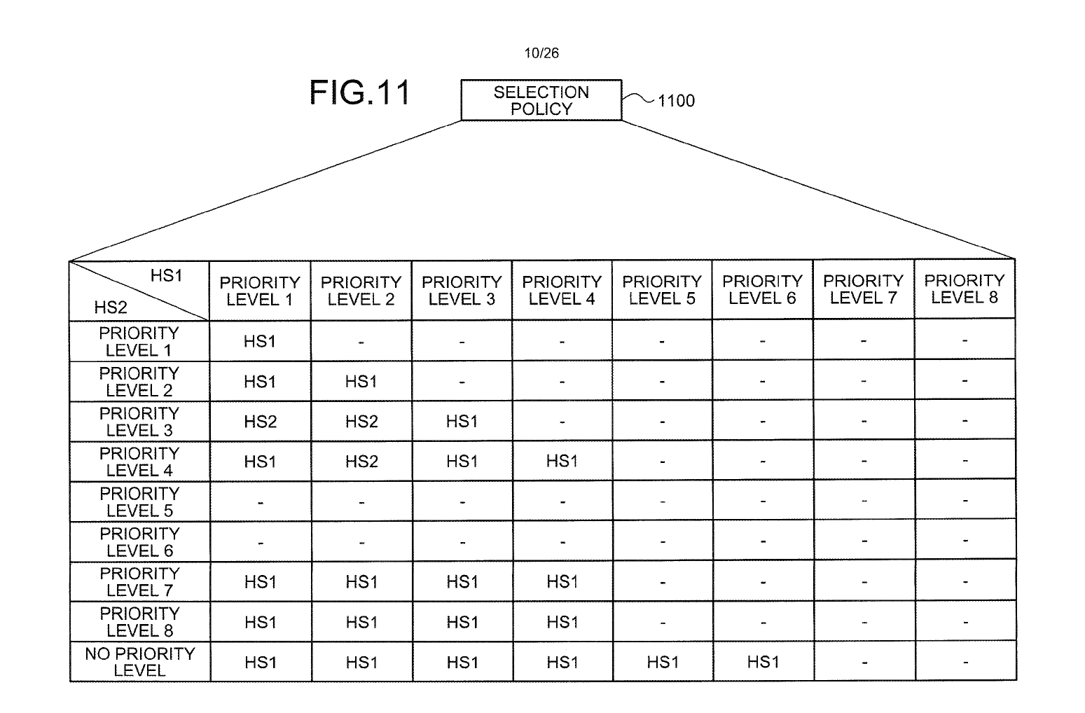

The RAID group number indicates identification information of the RAID group G to which the disk Di belongs. The priority level indicates a priority level given to a hot spare HS and is used when a hot spare to be incorporated into the RAID group G is retrieved. The priority level will be described in detail later with reference to FIG. 11.

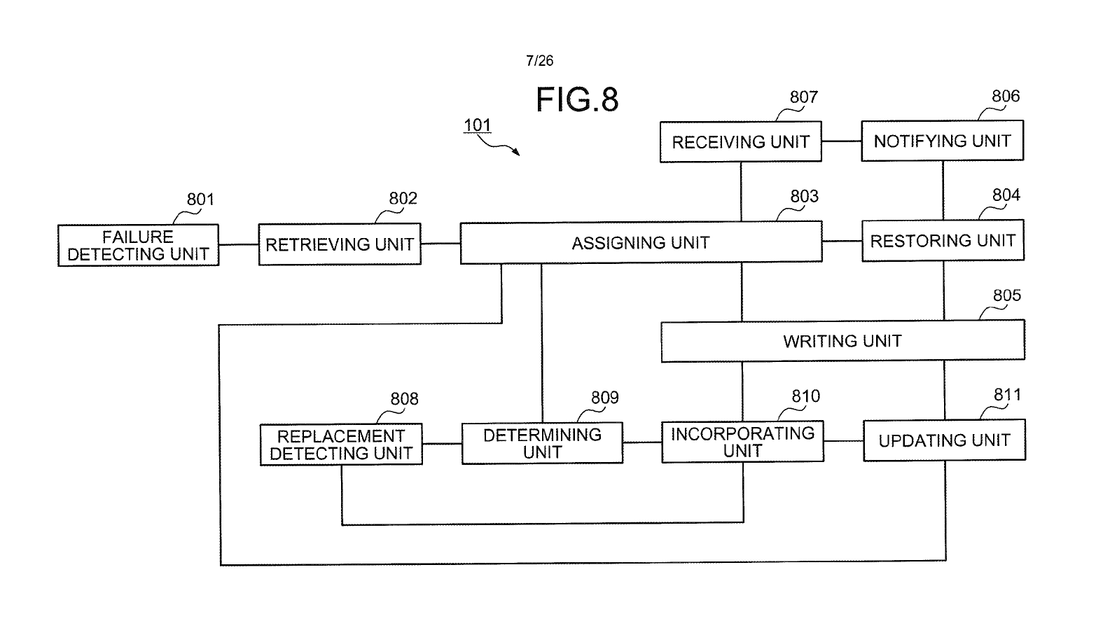

FIG. 8 is a block diagram of a functional configuration of the storage controller 101. In FIG. 8, the storage controller 101 includes a failure detecting unit 801, a retrieving unit 802, an assigning unit 803, a restoring unit 804, a writing unit 805, a notifying unit 806, a receiving unit 807, a replacement detecting unit 808, a determining unit 809, an incorporating unit 810, and an updating unit 811. Function of each of these functional units is implemented by, for example, causing the processor 401 to execute a program stored in the memory 402 or through the I/F 403. The result of processing by each functional unit is stored to, for example, the memory 402.

The failure detecting unit 801 has a function of detecting the failure of a disk Di in the RAID group G. For example, the failure detecting unit 801 may detect a failure of the disk Di when the reading and/or writing of data with respect to the disk Di doesnot be performed properly.

Upon detecting a failure of a disk Di in the RAID group G, the failure detecting unit 801 changes the state of the failed disk Di indicated in the disk management table 700 (see FIG. 7), from “normal” to “failure”. Through this process, a failed disk in the RAID group G may be identified.

The retrieving unit 802 has a function of searching the hot spares HS1 to HSm to retrieve a first hot spare HS and a second hot spare HS serving as substitute disks for a failed disk detected by the failure detecting unit 801. For example, the retrieving unit 802 retrieves the first hot spare HS and second hot spare HS, based on the memory capacity of each hot spare HSj and the memory capacity of the failed disk.

The retrieving unit 802 may retrieve the first hot spare HS and second hot spare HS, based on installation location information of the failed disk. The retrieving unit 802 may retrieve the first hot spare HS and second hot spare HS, based on installation location information of normal disks other than the failed disk of the RAID group G.

The installation location information is information for identifying the installation location of each disk or each hot spare HSj in the storage apparatus 301. For example, installation location information is information for identifying an enclosure in which each disk or each hot spare HSj is housed or a back end loop to which each disk or each hot spare HSj is connected.

The retrieving unit 802 may make a virtual disk, using unused hot spares not used as substitute disks, as one of the first and second hot spares HS. An example of the hot spare HS retrieving process will be described later.

The assigning unit 803 has a function such that when a failure of a disk Di in the RAID group G is detected, the assigning unit 803 incorporates the first and second hot spares HS into the RAID group G, as substitute storage units for the detected failed disk and assigns the first and second hot spares HS to the RAID group G as member disks.

For example, the assigning unit 803 may incorporate the first and second hot spares HS retrieved by the retrieving unit 802 into the RAID group G when the RAID group G has lost redundancy. The assigning unit 803 may incorporate the first and second hot spares HS specified by the worker terminal 303 (see FIG. 3) into the RAID group G.

For example, the assigning unit 803 enters the RAID group number of the RAID group G into the RAID group number space of the disk management table 700 for the first hot spare HS and similarly with respect to the disk management table 700 for the second hot spare HS. In addition, the assigning unit 803 enters the respective disk numbers of the first and second hot spares HS into the hot spare arrangement spaces of the RAID management table 600 for the RAID group G. As a result, the first and second hot spares HS are incorporated into the RAID group G, as substitute disks for the failed disk in the RAID group G.

The restoring unit 804 has a function of restoring the memory contents of the failed disk onto the first and second hot spares HS incorporated into the RAID group G by the assigning unit 803. For example, the restoring unit 804 restores the memory contents of the failed disk onto the first and second hot spares HS, based on the memory contents of disks D1 to Dn from which the failed disk is excluded.

In this manner, the redundancy of the RAID group G may be restored using the first and second hot spares HS incorporated into the RAID group G as the substitute disks for the failed disk.

When only one hot spare HS (e.g., first hot spare HS) is incorporated into the RAID group G, the restoring unit 804 may restore the memory contents of the failed disk onto the first hot spare HS.

In the following explanation, the process of restoring the memory contents of the failed disk in the RAID group G may be referred to as “rebuilding process for the RAID group G”. The process of restoring the memory contents of the failed disk onto the first and second hot spares HS incorporated into the RAID group G may be referred to as “duplicative rebuilding process for the RAID group G”. The process of restoring the memory contents of the failed disk onto one hot spare HS incorporated into the RAID group G may be referred to as “ordinary rebuilding process for the RAID group G”.

The writing unit 805 has a function such that if a write I/O request for the failed disk is made during execution of the rebuilding process for the RAID group G, the writing unit 805 writes writing data to the first hot spare and/or the second hot spare. By this function, the redundancy of the RAID group G may be restored without suspending tasks that use the RAID group G. Details of the process by the writing unit 805 will be described later.

The notifying unit 806 has a function such that when the rebuilding process for the RAID group G is completed, the notifying unit 806 outputs a completion notice indicating the completion of the rebuilding process for the RAID group G. The notifying unit 806 outputs the completion notice in various ways, such as displaying the notice on a display (not depicted), sending the notice to another computer through the I/F 403, and storing the notice to the memory 402.

For example, the notifying unit 806 may send the completion notice indicating the completion of the rebuilding process for the RAID group G to the worker terminal 303. This allows the worker, such as a CE, to know that the rebuilding process for the RAID group G has been completed.

The receiving function 807 has a function of receiving a notice of the start of work of replacing the failed disk in the RAID group G. For example, the receiving unit 807 may receive a notice of the start of work of replacing the failed disk in the RAID group G, from the worker terminal 303.

The assigning unit 803 releases a hot spare that is to be relocated that is one of the first and second hot spares HS incorporated into the RAID group G, from the RAID group G. The hot spare that is to be relocated is one of the first and second hot spares HS incorporated into the RAID group G that replaces the failed disk in the RAID group G.

In the following explanation, one of the first and second hot spares HS incorporated into the RAID group G that is different from the hot spare that is to be relocated may be referred to as “not-to-be transferred hot spare”.

For example, when receiving a notice of the start of work of replacing the failed disk in the RAID group G, the assigning unit 803 separates the hot spare that is to be relocated from the RAID group G to put the hot spare that is to be relocated in a state enabling separation from the storage apparatus 301. For example, the assigning unit 803 enters “-(null)” in the RAID group number space of the disk management table 700 for the hot spare that is to be relocated. In addition, the assigning unit 803 deletes from the hot spare arrangement space of the RAID management table 600 for the RAID group G, the disk number of the hot spare that is to be relocated.

Details of the process of selecting from among the first and second hot spares HS incorporated into the RAID group G, the hot spare that is to be relocated will be described later with reference to FIG. 11.

The assigning unit 803 may associate identification information of the hot spare that is to be relocated and separated from the RAID group G with identification information of the RAID group G and save the associated information. For example, the assigning unit 803 may associate the world wide name (WWN) of the hot spare that is to be relocated with the RAID group number of the RAID group G and save the associated WWN and RAID group number in the memory 402.

A WWN is a 64-bit address assigned to each disk and each hot spare HSj. Based on the WWN, each disk and each hot spare HSj may be identified uniquely. The assigning unit 803 may read the WWN from each disk and each hot spare HSj incorporated in the storage apparatus 301.

The replacement detecting unit 808 has a function of detecting the replacement of a failed disk in the RAID group G with a different disk. For example, the replacement detecting unit 808 detects the replacement of a failed disk in the RAID group G with a different disk when a failed disk has been removed from the storage apparatus 301 and thereafter, a different disk is installed in the installation location (e.g., slot) where the failed disk was located.

In the following description, a different disk that replaces a failed disk in the RAID group G may be referred to as “replacement disk”.

The determining unit 809 has a function such that when the failed disk in the RAID group G is replaced with the replacement disk, the determining unit 809 determines whether identification information of the replacement disk matches identification information of the hot spare that is to be relocated. For example, the determining unit 809 determines whether the WWN of the replacement disk matches the WWN that is associated with the RAID group number of the RAID group G and is saved in the memory 402 and that is of the hot spare that is to be relocated.

Through this process, whether the replacement disk that has replaced the failed disk in the RAID group disk is identical to the hot spare that is to be relocated may be determined.

The incorporating unit 810 has a function such that after the hot spare that is to be relocated is separated from the storage apparatus 301 as a result of the completion of the rebuilding process for the RAID group G, the incorporating unit 810 incorporates into the RAID group G, the replacement disk that has replaced the failed disk. For example, the incorporating unit 810 may incorporate the replacement disk into the RAID group G when the failed disk in the RAID group G has been replaced with the replacement disk.

For example, the incorporating unit 810 enters the RAID group number of the RAID group G into the RAID group number space of the disk management table 700 for the replacement disk. In addition, the incorporating unit 810 enters the disk number of the replacement disk into the member disk arrangement space for the failed disk of the RAID management table 600 for the RAID group G. Through this process, the replacement disk may be incorporated into the RAID group G in place of the failed disk.

The incorporating unit 810 may incorporate the replacement disk into the RAID group G if the determining unit 809 determines that identification information of the replacement disk matches identification information of the hot spare that is to be relocated. In this manner, when the hot spare that is to be relocated is provided as the replacement disk, the replacement disk may be incorporated into the RAID group G. This prevents a case where a disk not storing the restored memory contents of the failed disk is incorporated into the RAID group G.

If identification information of the replacement disk does not match identification information of the hot spare that is to be relocated, the storage controller 101 may put the replacement disk in a state enabling separation from the storage apparatus 301 and output a retry request to the worker terminal 303. A retry request is an alarm that prompts the worker to retry replacement work. Through this retry request, the worker, such as a CE, knows that the worker has provided the wrong disk as the replacement disk and therefore has to retry the replacement work.

If a write I/O request has been made during a period between the separation (from the RAID group G) of the hot spare that is to be relocated and the incorporation of the replacement disk into the RAID group G, the writing unit 805 writes writing data to a hot spare that is not to be relocated.

In the following description, the period between the separation of the hot spare that is to be relocated from the RAID group G and the incorporation of the replacement disk into the RAID group G may be referred to as “failed disk replacement work in progress”.

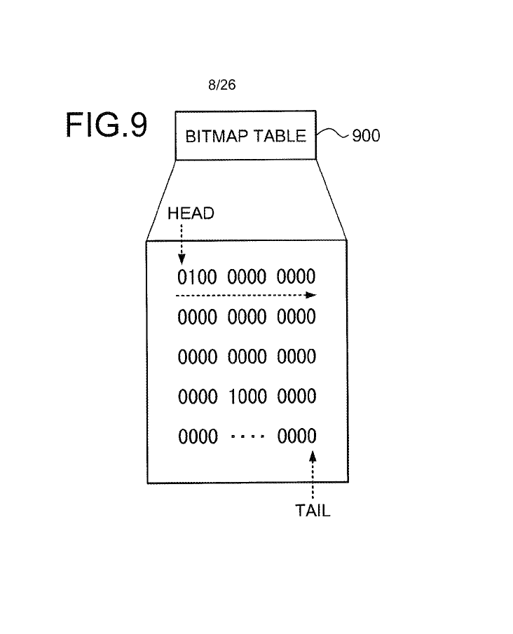

The writing unit 805 has a function of saving writing destination information indicating the writing destination to which the writing data has been written in the hot spare that is not to be relocated during failed disk replacement work. For example, the writing unit 805 may save the writing destination information indicating the writing destination of the writing data that has been written to the hot spare that is not to be relocated, using a bitmap table 900 depicted in FIG. 9.

The memory contents of the bitmap table 900 will be described. The bitmap table 900 is implemented by, for example, the memory 402 and is made for each hot spare that is not to be relocated in the RAID group G.

FIG. 9 is an explanatory diagram of an example of the memory contents of the bitmap table 900. In FIG. 9, the bitmap table 900 has a writing flag for each section created by dividing the memory area of the hot spare that is not to be relocated in the RAID group G by a given data size X.

A writing flag is 1-bit information indicating whether writing data has been written to a section. The writing flag is set to “0” in the initial state. The writing flag is set to “1” when writing data has been written to the section. The data size X by which the memory area of the hot spare that is not to be relocated is divided is, for example, 256 [KB].

For example, in the bitmap table 900, a bit string on the left end of the top row represents writing flags in the head section of the hot spare that is not to be relocated. Each bit string represents writing flags arranged in the order of address in each section from the left to the right. In the bitmap table 900, a bit string on the right end of the bottom row represents writing flags in the tail section of the hot spare that is not to be relocated.

A case is assumed where writing data is written to the head section of the hot spare that is not to be relocated. In this case, the writing unit 805 changes a writing flag in the bit string on the left end of the top row, from “0” to “1”.

Use of the bitmap table 900 enables identification of a writing destination for writing data that has been written to the hot spare that is not to be relocated during failed disk replacement work. Managing writing flags according to sections created by dividing the memory area of the hot spare that is not to be relocated, by the given data size reduces the amount of the memory 402 used for saving the writing destination information indicating the writing destinations of writing data.

For example, when a memory area of 256 [KB] is managed by 1-bit data, the size of a table required for monitoring to detect a new write I/O request for a disk D with a memory capacity of 2 [TB] is calculated as “1024*1024*1024*2/256/8”=1048576 [bytes]=1 [MB].

FIG. 8 is referred to again. The updating unit 811 has a function such that when incorporation of the replacement disk into the RAID group G is completed, the updating unit 811 refers to the writing destination information saved by the writing unit 805 and writes to the replacement disk, the writing data stored in the hot spare that is not to be relocated.

For example, the updating unit 811 refers to the bitmap table 900 of FIG. 9 and reads data out of a section of the hot spare that is not to be relocated and for which a writing flag of “1” is set. The updating unit 811 then writes the data read out from the section of the hot spare that is not to be relocated, to a memory area in the hot spare that is to be relocated and corresponding to the section from which the data is read out.

As a result, the memory contents of the hot spare that is to be relocated become equivalent to the memory contents of the hot spare that is not to be relocated. If a write I/O request for the hot spare that is to be relocated is made during the updating of the memory contents of the hot spare that is to be relocated, for example, the updating unit 811 temporarily saves the write I/O request to the memory 402 and then executes a writing process according to the saved write I/O request after the completion of the updating of the memory contents.

When the updating unit 811 has finished writing the writing data to the replacement disk, the assigning unit 803 may separate the hot spare that is not to be relocated from the RAID group G. For example, the assigning unit 803 enters “-(null)” in the RAID group number space of the disk management table 700 for the hot spare that is not to be relocated. In addition, the assigning unit 803 deletes from the hot spare arrangement space of the RAID management table 600 for the RAID group G, the disk number of the hot spare that is not to be relocated. In this manner, the hot spare that is not to be relocated and is incorporated in the RAID group G is released from the RAID group G and may be used as a substitute storage.

When the hot spare that is not to be relocated has been separated from the RAID group G, the writing unit 805 may delete the writing destination information indicating the writing destination for the writing data written to the hot spare that is not to be relocated during the failed disk replacement work. For example, when the hot spare that is not to be relocated has been separated from the RAID group G, the writing unit 805 may delete from the memory 402, the bitmap table 900 for the RAID group G. In this manner, the bitmap table 900 for the RAID group G restored to the original state before the occurrence of the disk failure is deleted from the memory 402 to reduce the amount of the memory 402 used.

When the failure of a disk Di in the RAID group G has been detected, the notifying unit 806 may output a failure notice indicating the failure of the disk Di. For example, the notifying unit 806 may send the failure notice indicating the failure of the disk Di in the RAID group G, to the worker terminal 303. Through this notice, the worker, such as a CE, knows that the disk Di in the RAID group G has failed.

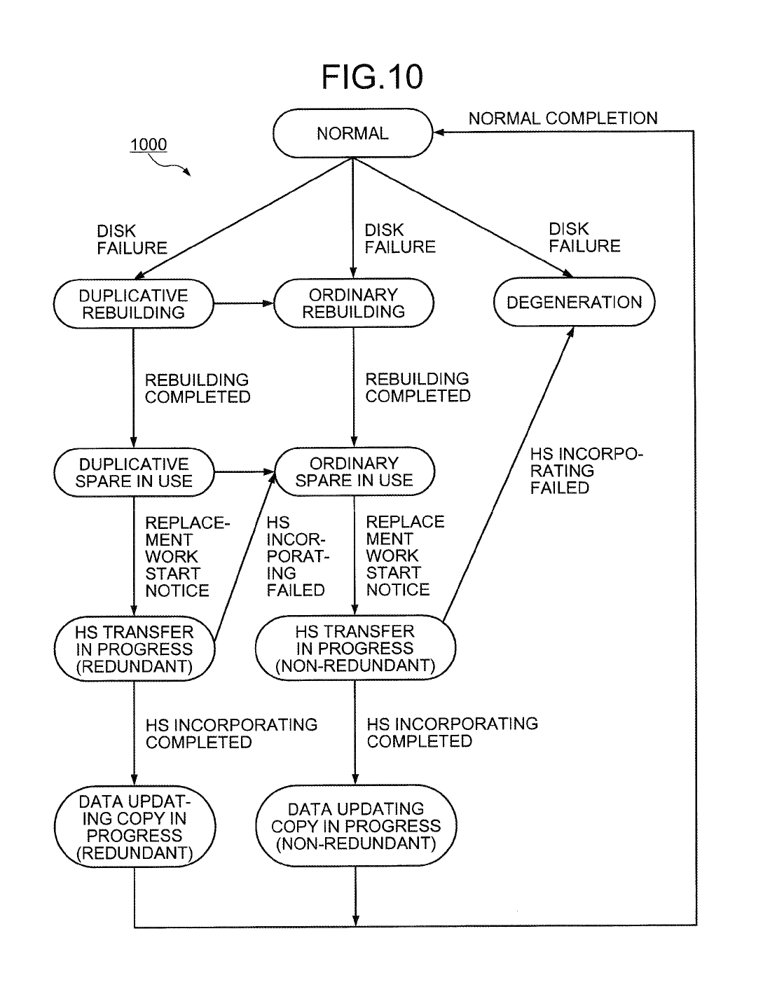

A state transition of the RAID group G consequent to disk failure will be described. FIG. 10 is an explanatory diagram of an example of a transition of the state of the RAID group G. In FIG. 10, a state transition diagram 1000 depicts a series of state transitions of the RAID group G occurring with disk failure.

When a disk of the RAID group G fails, the state of the RAID group G shifts from “Normal” to “Duplicative Rebuilding” or “Normal Rebuilding” or “Degeneration”. “Duplicative Rebuilding” represents a state in which a rebuilding process using two hot spares HS (first and second hot spares HS) is being executed. “Normal Rebuilding” represents a state in which a rebuilding process using one hot spare HS (first hot spare HS) is being executed. “Degeneration” represents a state in which data redundancy is lost.

When the rebuilding process for the RAID group G in the “Duplicative Rebuilding” state is completed, the state of the RAID group G transitions to “Duplicative Spare in Use”, which represents a state in which data redundancy is restored using two hot spares HS following the completion of the rebuilding process.

When a notice of the start of work of replacing the failed disk in the RAID group G in the “Duplicative Spare in Use” state is received, the state of the RAID group G transitions to “HS Transfer in Progress (Redundant)”, which represents a state in which one hot spare (hot spare that is to be relocated) out of two hot spares HS incorporated into the RAID group G is separated from the RAID group G.

When incorporation of the replacement disk (hot spare that is to be relocated) into the RAID group G in the “HS Transfer in Progress (Redundant)” state is completed, the state of the RAID group G transitions to “Data Updating Copy in Progress (Redundant)”, which represents a state in which the memory contents of the replacement disk is being updated based on the memory contents of a hot spare that is not to be relocated.

When the updating of the memory contents of the replacement disk in the RAID group G in the “Data Updating Copy in Progress (Redundant)” state is completed and the hot spare that is not to be relocated has been separated from the RAID group G, the state of the RAID group G transitions to “Normal”.

When the rebuilding process for the RAID group G in the “Normal Rebuilding” state is completed, the state of the RAID group G transitions to “Normal Spare in Use”, which represents a state in which data redundancy is restored using one hot spare HS following the completion of the rebuilding process.

When a notice of the start of work of replacing the failed disk in the RAID group G in the “Normal Spare in Use” state is received, the state of the RAID group G transitions to “HS Transfer in Progress (Non-Redundant)”, which represents a state in which one hot spare (hot spare that is to be relocated) incorporated into the RAID group G is separated from the RAID group G.

When incorporation of the replacement disk into the RAID group G in the “HS Transfer in Progress (Non-Redundant)” state is completed, the state of the RAID group G transitions to “Data Updating Copy in Progress (Non-Redundant)”, which represents a state in which the memory contents of the replacement disk is being updated based on the memory contents of a normally functional disk.

When the updating of the memory contents of the replacement disk in the RAID group G in the “Data Updating Copy in Progress (Non-Redundant)” state is completed, the state of the RAID group G transitions to “Normal”.

If incorporation of the replacement disk (hot spare that is to be relocated) into the RAID group G in the “HS Transfer in Progress (Redundant)” state ends in failure, the state of the RAID group G transitions to “Normal Spare in Use”. If incorporation of the replacement disk into the RAID group G in the “HS Transfer in Progress (Non-Redundant)” state ends in failure, the state of the RAID group G transitions to “Degeneration”.

Details of a process of retrieving the first and second hot spares serving as substitute disks for the failed disk will be described.

The retrieving unit 802 searches the hot spares HS1 to HSm to retrieve a hot spare HS satisfying a first search condition. The hot spare HS satisfying the first search condition is an unused hot spare HS defined in the (a-1) or (a-2) below. An unused hot spare means a hot spare HS not incorporated into the RAID group G as a substitute disk.

(a-1) A hot spare connected to the same back end loop to which the failed disk in the RAID group G is connected

(a-2) A hot spare HS connected to a back end loop other than a back end loop to which a normally functioning disk different from the failed disk in the RAID group G is connected

A back end loop to which each hot spare HSj is connected may be identified based on installation location information stored in the memory 402 or may be identified by the retrieving unit 802 which accesses each hot spare HSj.

When having retrieved hot spares HS satisfying the first search condition, the retrieving unit 802 searches the hot spares HS satisfying the first search condition to retrieve a hot spare HS defined by (i) below.

(i) A hot spare HS having the same memory capacity as the memory capacity of the failed disk in the RAID group G

If two hot spares defined by (i) have been retrieved, the assigning unit 803 incorporates the retrieved two hot spares HS into the RAID G, as the first and second hot spares. If one hot spare defined by (i) has been retrieved, the assigning unit 803 incorporates the retrieved one hot spare HS into the RAID G, as the first hot spare.

A priority level of “1” is given to the hot spare HS satisfying the first search condition and defined by (i). The priority level is an index that is used when the hot spare that is to be relocated is selected from among the first and second hot spares.

If the incorporation of the first and second hot spares is not completed, the retrieving unit 802 searches the hot spares satisfying the first search condition to retrieve a hot spare HS defined by (ii) below.

(ii) A hot spare HS having the lowest memory capacity among hot spares HS having memory capacities greater than or equal to the memory capacity of the failed disk in the RAID group G

If a hot spare HS defined by (ii) has been retrieved, the assigning unit 803 incorporates the retrieved hot spare into the RAID group G, as the first hot spare or second hot spare not incorporated yet. A priority level of “2” is given to the hot spare HS satisfying the first search condition and defined by (ii).

Subsequently, if the incorporation of the first and second hot spares HS is not completed, the retrieving unit 802 searches the hot spares HS1 to HSm to retrieve a hot spare HS satisfying a second search condition. The hot spare HS satisfying the second search condition is an unused hot spare HS defined by (b) below.

(b) A hot spare HS connected to a back end loop to which a normally functioning disk different from the failed disk in the RAID group G is connected

When having retrieved hot spares HS satisfying the second search condition, the retrieving unit 802 searches the hot spares satisfying the second search condition to retrieve a hot spare HS defined by (i).

If a hot spare HS defined by (i) has been retrieved, the assigning unit 803 incorporates the retrieved hot spare into the RAID group G, as the first hot spare or second hot spare not incorporated yet. A priority level of “3” is given to the hot spare HS satisfying the second search condition and defined by (i).

If the incorporation of the first and second hot spares is not completed, the retrieving unit 802 searches the hot spares satisfying the second search condition to retrieve a hot spare HS defined by (ii).

If a hot spare HS defined by (ii) has been retrieved, the assigning unit 803 incorporates the retrieved hot spare into the RAID group G, as the first hot spare or second hot spare not incorporated yet. A priority level of “4” is given to the hot spare HS satisfying the second search condition and defined by (ii).

Subsequently, if the incorporation of the first hot spare HS is not completed yet, the retrieving unit 802 searches the hot spares HS1 to HSm to retrieve a hot spare HS satisfying a third search condition. The hot spare HS satisfying the third search condition is a hot spare HS defined by (c) below.

(c) A hot spare HS having the lowest priority level among the first and second hot spares HS incorporated in the RAID group G of which the state is “Duplicative Rebuilding” or “Duplicative Spare In Use”

When having retrieved hot spares HS satisfying the third search condition, the retrieving unit 802 searches the hot spares HS satisfying the third search condition to retrieve a hot spare HS defined by (i).

If the hot spare HS defined by (i) has been retrieved, the assigning unit 803 captures the retrieved hot spare HS from another RAID group G and incorporates the captured hot spare into the RAID group G, as the first hot spare. At this time, the assigning unit 803 deletes the disk number of the captured hot spare, from the hot spare arrangement space of the RAID management table 600 for the other RAID group G. A priority level of “5 is given to the hot spare HS satisfying the third search condition and defined by (i).

Subsequently, if the incorporation of the first hot spare HS is not completed yet, the retrieving unit 802 searches the hot spares HS satisfying the third search condition to retrieve a hot spare HS defined by (ii).

If the hot spare HS defined by (ii) has been retrieved, the assigning unit 803 captures the retrieved hot spare HS from another RAID group G and incorporates the captured hot spare into the RAID group G, as the first hot spare. At this time, the assigning unit 803 deletes the disk number of the captured hot spare, from the hot spare arrangement space of the RAID management table 600 for the other RAID group G. A priority level of “6” is given to the hot spare HS satisfying the third search condition and defined by (ii).

Subsequently, if the incorporation of the second hot spare HS is not completed yet, the retrieving unit 802 searches the hot spares HS1 to HSm to retrieve a hot spare HS satisfying a fourth search condition. The hot spare HS satisfying the fourth search condition is an unused hot spare HS defined by (d) below.

(d) A hot spare HS among hot spares HS having memory capacities smaller than the memory capacity of the failed disk and having a memory capacity greater than or equal to 1/K of the memory capacity of the failed disk in the RAID group G, where K is a coefficient for which the value may be set arbitrarily (e.g., K=2).

When having retrieved hot spares HS satisfying the fourth search condition, the retrieving unit 802 searches the hot spares HS satisfying the fourth search condition to retrieve a hot spare HS defined by (iii) or (iv).

(iii) A hot spare HS connected to the same back end loop to which the failed disk in the RAID group G is connected

(iv) A hot spare HS connected to a back end loop other than a back end loop to which a normally functioning disk different from the failed disk in the RAID group G is connected

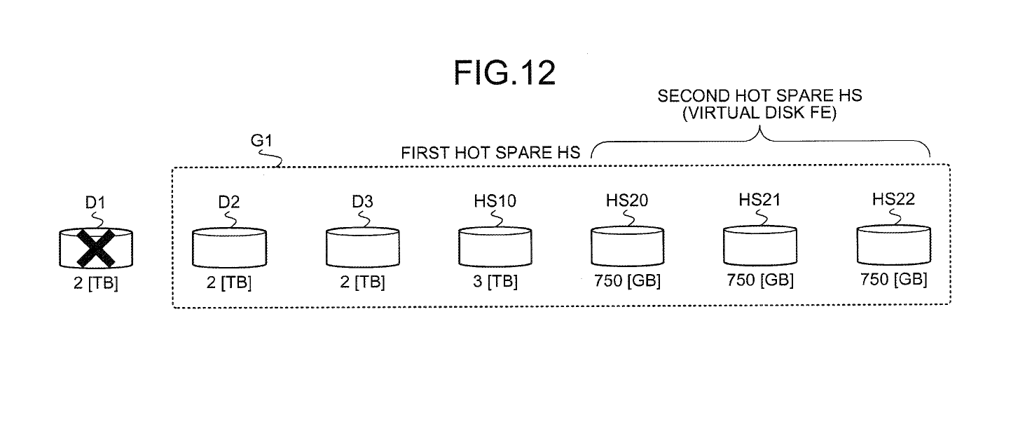

If K hot spares defined by (iii) or (iv) have been retrieved, the assigning unit 803 makes a single virtual disk using the retrieved K hot spares HS and incorporates the virtual disk into the RAID group G, as the second hot spare HS. A priority level of “7” is given to the virtual disk formed by the K hot spares HS satisfying the fourth search condition and defined by (iii) or (iv). An example of making a virtual disk will be described later with reference to FIG. 12.

Subsequently, if the incorporation of the second hot spare HS is not completed yet, the retrieving unit 802 searches the hot spares satisfying the fourth search condition to retrieve a hot spare defined by (v) below.

(v) A hot spare HS connected to a back end loop to which a normally functioning disk different from the failed disk in the RAID group G is connected

If two hot spares defined by (iii) or (iv) or (v) have been retrieved, the assigning unit 803 makes a single virtual disk using the retrieved two hot spares HS and incorporates the virtual disk into the RAID group G, as the second hot spare HS. A priority level of “8” is given to the virtual disk formed by the two hot spares HS satisfying the fourth search condition and defined by (iii) or (iv) or (v).

If the incorporation of the second hot spare HS is not completed, the retrieving unit 802 may change the coefficient K of the fourth search condition (e.g., K=3) and execute the retrieving process of retrieving K hot spares in the same manner as described above.

If the memory capacity of hot spares HS the storage apparatus 301 supports is predetermined, the coefficient K of the fourth search condition may be set according to the specified memory capacity.

In this manner, a retrieval the first and second hot spares HS based on the first to fourth search conditions prevents a situation where storage units ST of the RAID group G are housed in the same enclosure or connected to the same back end loop in a biased configuration, thereby reducing the risk that a breakdown of a certain enclosure brings the RAID group G into a state of failure.

Details of a process of selecting from among the first and second hot spares HS incorporated in the RAID group G, a hot spare that is to be relocated will be described. A selection policy 1100 used in the selection of the hot spare that is to be relocated will be described.

FIG. 11 is an explanatory diagram of an example of the selection policy 1100. In FIG. 11, the selection policy 1100 represents a policy that is followed when the hot spare that is to be relocated is selected from among the first and second hot spares HS. In FIG. 11, HS1 denotes the first hot spare HS incorporated in the RAID group G and HS2 denotes the second hot spare HS incorporated in the RAID group G.

Referring to the selection policy 1100, the assigning unit 803 selects from among the first and second hot spares HS incorporated in the RAID group G, the hot spare that is to be relocated. According to the selection policy 1100, the hot spare that is to be relocated is selected by considering that the hot spare that is to be relocated has the same memory capacity as the memory capacity of the failed disk and that loop redundancy is maintained during failed disk replacement work.

For example, if the priority level of HS1 is “1” and the priority level of HS2 is also “1”, the assigning unit 803 refers to the selection policy 1100 and selects the first hot spare incorporated in the RAID group G, as the hot spare that is to be relocated. If the priority level of HS1 is “2” and the priority level of HS2 is also “3”, the assigning unit 803 refers to the selection policy 1100 and selects the second hot spare incorporated in the RAID group G, as the hot spare that is to be relocated.

The notifying unit 806 may output a transfer notice for identifying the hot spare that is to be relocated as selected by the assigning unit 803. The transfer notice includes information indicating the disk number and placement location of the hot spare that is to be relocated. For example, the notifying unit 806 may send the transfer notice for identifying the hot spare that is to be relocated, to the worker terminal 303. Through this transfer notice, the worker, such as a CE, knows the hot spare HS that is to be removed from the storage apparatus 301 as a replacement disk to replace the failed disk.

An example of creating a virtual disk will be described. A case of a failure of the disk D1 in the RAID group G1 of FIG. 5 will be taken as an example in which a virtual disk is created as the second hot spare HS to be incorporated into the RAID group G1.

FIG. 12 is an explanatory diagram of an example of creating a virtual disk. In FIG. 12, as a result of a failure of the disk D1 in the RAID group G1, the first and second hot spares HS are incorporated into the RAID group G1.

The first hot spare HS has a memory capacity (3 [TB]) greater than or equal to the memory capacity of the failed disk D1 (2 [TB]). The second hot spare HS is a virtual disk FE having a memory capacity (2250 [GB]) greater than or equal to the memory capacity of the failed disk D1 (2 [TB]).

The virtual disk FE is a single logical disk formed by combining together hot spares HS20, HS21, and HS22. In this manner, if two hot spares HS respectively having memory capacities greater than or equal to the memory capacity of the failed disk D1 are not present, multiple hot spares HS are combined to create the virtual disk FE that is incorporated into the RAID group G1 as the second hot spare HS.

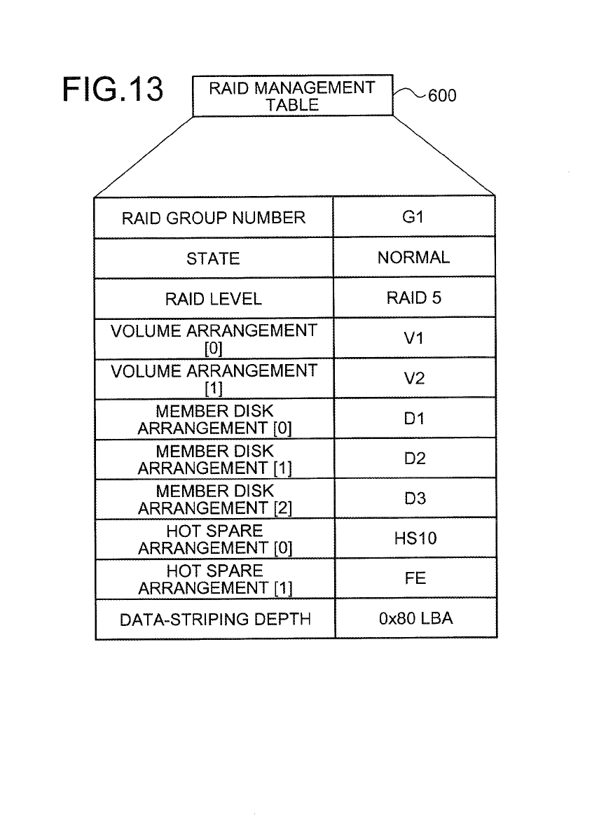

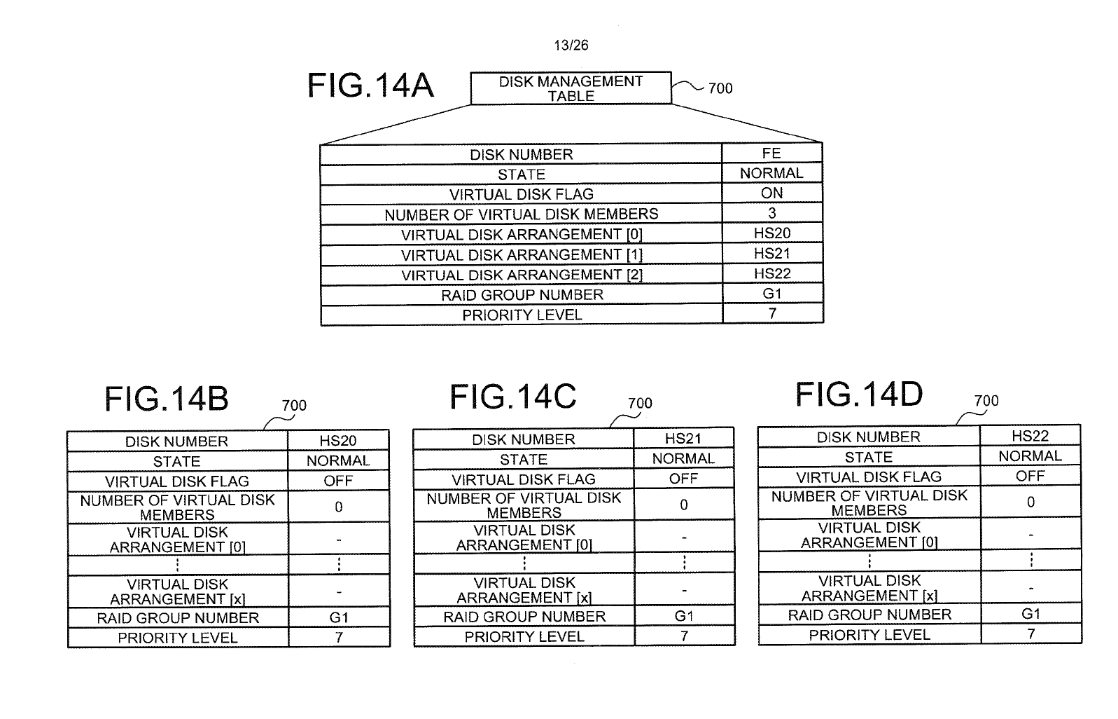

The memory contents of the RAID management table 600 for the RAID group G1 into which the virtual disk FE is incorporated as the second hot spare HS will be described with reference to FIG. 13. The memory contents of the disk management table 700 for the virtual disk FE incorporated into the RAID group G1 will be described with reference to FIG. 14.

FIG. 13 is an explanatory diagram (2) of an example of the memory contents of the RAID management table 600. In FIG. 13, the disk number “HS10” of the hot spare HS10 incorporated in the RAID group G1 and the disk number “FE” of the virtual disk FE are entered in the hot spare arrangement spaces of the RAID management table 600.

FIGS. 14A, 14B, 14C, AND 14D are explanatory diagrams (2) of an example of the memory contents of the disk management table 700. In FIG. 14A, “ON” and “3” are entered in the virtual disk flag space and the virtual disk member count space, respectively, in the disk management table 700 for the virtual disk FE. The disk numbers “HS20, HS21, HS22” of the hot spares HS20, HS21, and HS22 forming the virtual disk FE are entered in the virtual disk arrangement spaces for arrangements [0] to [2] in the disk management table 700 for the virtual disk FE.

FIGS. 14B, 14C, and 14D depict three disk management tables 700 under the disk management table 700 for the virtual disk FE. These three disk management tables 700 are indicated as disk management tables 700 made for the hot spares HS20, HS21, and HS22 forming the virtual disk FE, respectively.

Details of a process by the writing unit 805 will be described. The details of the process by the writing unit 805 vary according to the states of the RAID group G. The details of the process by the writing unit 805 for each state of the RAID group G will be described.

When the state of the RAID group G is “Normal”, the writing unit 805 writes writing data to a disk Di for which a write I/O request is made.

When the state of the RAID group G is “Normal Rebuilding”, the writing unit 805 determines whether the memory area relevant to the write I/O request has been rebuilt. If the memory area relevant to the write I/O request has been rebuilt, the writing unit 805, in response to a write I/O request for the failed disk, writes writing data to the hot spare that is to be relocated. The writing unit 805 processes a read I/O request for the failed disk in the same manner.

If the memory area relevant to the write I/O request has not been rebuilt yet, the writing unit 805 performs Degenerative Write in response to the write I/O request for the failed disk. If the RAID group G is at a RAID level for mirroring, Degenerative Write means writing data to a redundant disk. If the RAID group G is at a RAID level for using parity check, Degenerative Write means writing parity data that allows data matching to data stored in a normal disk in the RAID group G.

If the memory area relevant to the read I/O request is not rebuilt yet, the writing unit 805 performs Degenerative Read in response to the read I/O request for the failed disk. When the RAID group G is at a RAID level for mirroring, Degenerative Read means data reading from a redundant disk. When the RAID group G is at a RAID level for using parity check, Degenerative Read means restoring data from an ordinary disk in the RAID group G by executing XOR, etc.

When the state of the RAID group G is “Normal Spare in Use”, the writing unit 805, in response to the write I/O request for the failed disk, writes writing data to the hot spare that is to be relocated. The writing unit 805 processes a read I/O request for the failed disk in the same manner.

When the state of the RAID group G is “Duplicative Rebuilding”, the writing unit 805 determines whether a memory area relevant to the write I/O request has been rebuilt. If the memory area relevant to the write I/O request has been rebuilt, the writing unit 805 writes, in response to the write I/O request for the failed disk, writing data to the hot spare that is to be relocated and to a hot spare that is not to be relocated. If the memory area relevant to the write I/O request is not rebuilt yet, the writing unit 805 performs Degenerative Write in response to the write I/O request for the failed disk. The writing unit 805 processes a read I/O request for the failed disk in the same manner.

When the state of the RAID group G is “Degeneration”, the writing unit 805 performs Degenerative Write in response to the write I/O request for the failed disk. The writing unit 805 processes a read I/O request for the failed disk in the same manner.

When the state of the RAID group G is “HS Transfer in Progress (Non-Redundant)”, the writing unit 805 performs Regenerative Write in response to the write I/O request for the replacement disk. At this time, the writing unit 805 updates the bitmap table 900. The writing unit 805 processes a read I/O request for the replacement disk in the same manner.

When the state of the RAID group G is “HS Transfer in Progress (Redundant)”, the writing unit 805, in response to the write I/O request for the replacement disk, writes writing data to the hot spare that is not to be relocated. At this time, the writing unit 805 updates the bitmap table 900. The writing unit 805 processes a read I/O request for the replacement disk in the same manner.

When the state of the RAID group G is “Data Updating Copy in Progress (Redundant)”, the writing unit 805 refers to the bitmap table 900 and determines whether updating the memory area relevant to the write I/O request is necessary, which means that the writing unit 805 determines whether a writing flag in the memory area relevant to the write I/O request is set to “1”.

If updating the memory area relevant to the write I/O request is not necessary, the writing unit 805 writes writing data to the disk Di to which the write I/O request is made. The writing unit 805 processes a read I/O request in the same manner.

If updating the memory area relevant to the write I/O request is necessary, the writing unit 805 copies data stored in the hot spare that is to be relocated to the replacement disk and then writes writing data to the disk Di for which the write I/O request is made. The writing unit 805 processes a read I/O request in the same manner.

When the state of the RAID group G is “Data Updating Copy in Progress (Non-Redundant)”, the writing unit 805 refers to the bitmap table 900 and determines whether updating the memory area relevant to the write I/O request is necessary.

If updating the memory area relevant to the write I/O request is not necessary, the writing unit 805 writes writing data to the disk Di for which the write I/O request is made. The writing unit 805 processes a read I/O request in the same manner.

If updating the memory area relevant to the write I/O request is necessary, the writing unit 805 copies data restored from an ordinary disk in the RAID group G through XOR, etc., to the replacement disk and then writes writing data to the disk Di for which the write I/O request is made. The writing unit 805 processes a read I/O request in the same manner.

An example of calculation of an address to be accessed when an access request (read/write I/O request) is made will be described by taking the RAID group G1 of FIG. 12 as an example. The data-striping depth of the RAID group G1 is “0×80 LBA (128 LBA in the decimal notation)”.

A case is assumed where a request for access to LBA=0×00100024 on the failed disk D1 in the RAID group G1 is made. In this case, an access request is made for the hot spare HS10 incorporated in the RAID group G1 as a substitute disk for the failed disk D1 and for the virtual disk FE.

In response to the access request for the hot spare HS10, the storage controller 101 accesses LBA=0×00100024 on the hot spare HS10 and executes an I/O process. In response to the access request for the virtual disk FE, the storage controller 101 determines a physical disk and an address to which the storage controller 101 actually makes access, in the following manner.

$$\begin{matrix}Disk to be accessed = virtual disk arrangement \\ [ ( 0 x 00100024 / 0 x 80 ) \%3 ] \\ = virtual disk arrangement [ 0 x 2000 \%3 ] \\ = virtual disk arrangement [ 2 ] \\ = hot spare HS 22\end{matrix}$$

where “%3” represents the remainder of division by 3.

$$\begin{matrix}Address to be accessed = 0 x 00100024 / ( 0 x 80 * 3 ) * 0 x 80 + \\ 0 x 00100024 \% 0 x 80 \\ = ( 0 x 00100024 / 0 x 180 ) * \\ 0 x 80 + 0 x 00100024 \% 0 x 80 \\ = 0 xAAA * 0 x 80 + 0 x 24 \\ = 0 x 55500 + 0 x 24 \\ = 0 x 55524\end{matrix}$$

In this manner, when accessing LBA=0×00100024 on the virtual disk FE, the storage controller 101 actually accesses 0×55524 LBA on the hot spare HS22 to execute the I/O process.

Various procedures by the storage controller 101 will be described. A rebuilding procedure by the storage controller 101 will be described first.

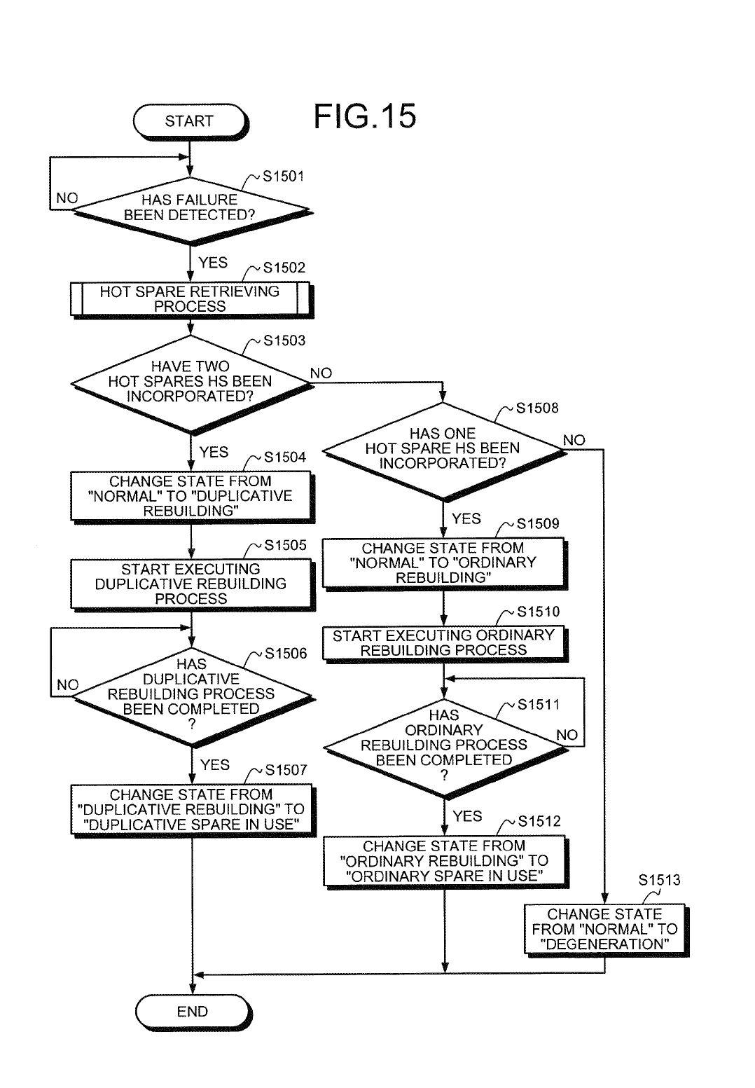

FIG. 15 is a flowchart of an example of the rebuilding procedure by the storage controller 101. In the flowchart of FIG. 15, the storage controller 101 first determines whether it has detected a failure of a disk Di in the RAID group G (step S1501).

The storage controller 101 stands by until the failure of a disk Di in the RAID group G is detected (step S1501: NO). Upon detecting the failure of the disk Di (step S1501: YES), the storage controller 101 executes a hot spare retrieving process (step S1502).

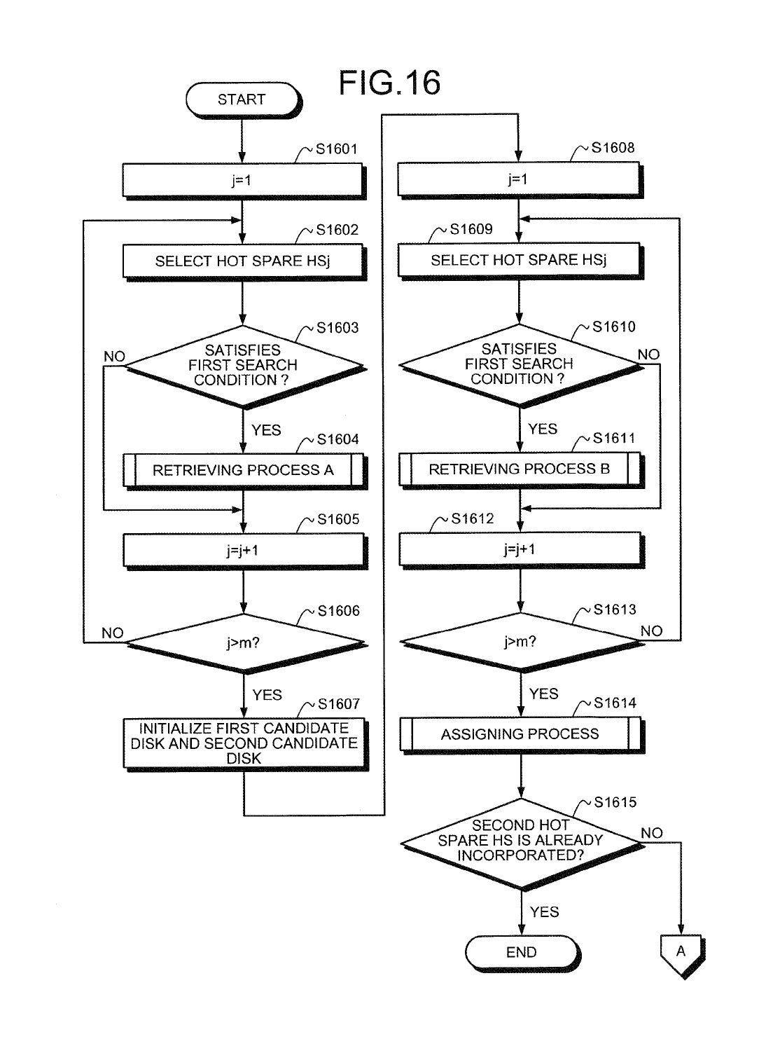

The hot spare retrieving process is a process of retrieving a hot spare that is to be incorporated into the RAID group G as a substitute disk for the failed disk. Details of the hot spare retrieving process will be described later with reference to FIGS. 16 to 20.

The storage controller 101 determines whether two hot spares HS have been incorporated into the RAID group G (step S1503). If two hot spares HS are incorporated into the RAID group G (step S1503: YES), the storage controller 101 changes the state of the RAID group G from “Normal” to “Duplicative Rebuilding” (step S1504).

The storage controller 101 starts executing a duplicative rebuilding process (step S1505). The storage controller 101 determines whether the duplicative rebuilding process has been completed (step S1506). The storage controller 101 stands by until the duplicative rebuilding process is completed (step S1506: NO).

When the duplicative rebuilding process is completed (step S1506: YES), the storage controller 101 changes the state of the RAID group G from “Duplicative Rebuilding” to “Duplicative Spare in Use” (step S1507), and ends the series of operations according to the flowchart.

If two hot spares HS have not been incorporated into the RAID group G at step S1503 (step S1503: NO), the storage controller 101 determines whether one hot spare HS has been incorporated into the RAID group G (step S1508).

If one hot spare HS has been incorporated into the RAID group G (step S1508: YES), the storage controller 101 changes the state of the RAID group G from “Normal” to “Ordinary Rebuilding” (step S1509).

The storage controller 101 starts executing an ordinary rebuilding process (step S1510). The storage controller 101 determines whether the ordinary rebuilding process has been completed (step S1511). The storage controller 101 stands by until the ordinary rebuilding process has been completed (step S1511: NO).

When the ordinary rebuilding process has been completed (step S1511: YES), the storage controller 101 changes the state of the RAID group G from “Ordinary Rebuilding” to “Ordinary Spare in Use” (step S1512), and ends the series of operations according to the flowchart.

If no hot spare HS has been incorporated into the RAID group G at step S1508 (step S1508: NO), the storage controller 101 changes the state of the RAID group G from “Normal” to “Degeneration” (step S1513), and ends the series of operations according to the flowchart.

Through this procedure, when a disk failure occurs in the RAID group G, the memory contents of the failed disk may be restored onto a hot spare HS incorporated into the RAID group G. Hence, the redundancy of the RAID group G is restored.

If the state of the RAID group G changes from “Normal” to “Degeneration” at step S1513, the storage controller 101 may send to the worker terminal 303, a degeneration notice indicating that the RAID group G has lost redundancy. Receiving this notice, a worker, such as a CE, knows that the RAID group G has lost redundancy.

A procedure of the hot spare retrieving process at step S1502 of FIG. 15 will be described.

FIGS. 16, 17, 18, 19, and 20 are flowcharts of an example of the specific procedure of the hot spare retrieving process. In the flowchart of FIG. 16, the storage controller 101 sets “j” of a hot spare HSj to “j=1” (step S1601), and selects the hot spare HSj from among hot spares HS1 to HSm (step S1602).

The storage controller 101 determines whether the selected hot spare HSj satisfies the first search condition (step S1603). A hot spare HS satisfying the first search condition is an unused hot spare HS defined by (a-1) or (a-2) described above.

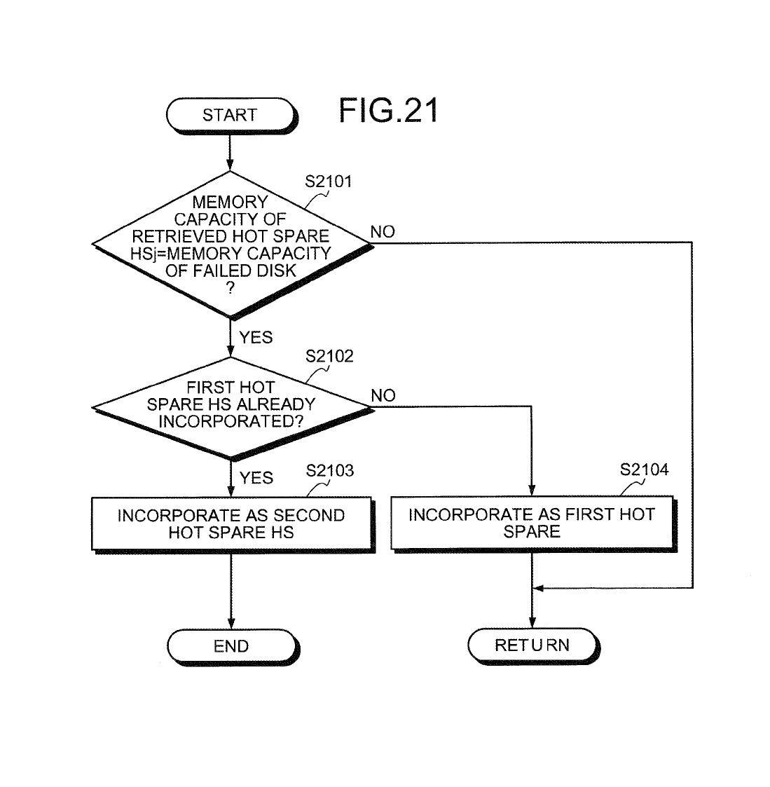

If the hot spare HSj does not satisfy the first search condition (step S1603: NO), the storage controller 101 proceeds to step S1605. If the hot spare HSj satisfies the first search condition (step S1603: YES), the storage controller 101 executes a retrieving process A (step S1604). A procedure of the retrieving process A will be described later with reference to FIG. 21.

The storage controller 101 increases the value of “j” of the hot spare HSj by 1 (step S1605), and determines whether “j” is greater than “m” (step S1606). If “j” is less than or equal to “m” (step S1606: NO), the storage controller 101 returns to step S1602.

If “j” is greater than “m” (step S1606: YES), the storage controller 101 initializes a first candidate disk and a second candidate disk (step S1607). The first candidate disk and the second candidate disk are candidates for the first hot spare HS and the second hot spare HS to be incorporated into the RAID group G.

The storage controller 101 sets “j” of the hot spare HSj to “j=1” (step S1608), and selects the hot spare HSj from among the hot spares HS1 to HSm (step S1609). The storage controller 101 determines whether the selected hot spare HSj satisfies the first search condition (step S1610).

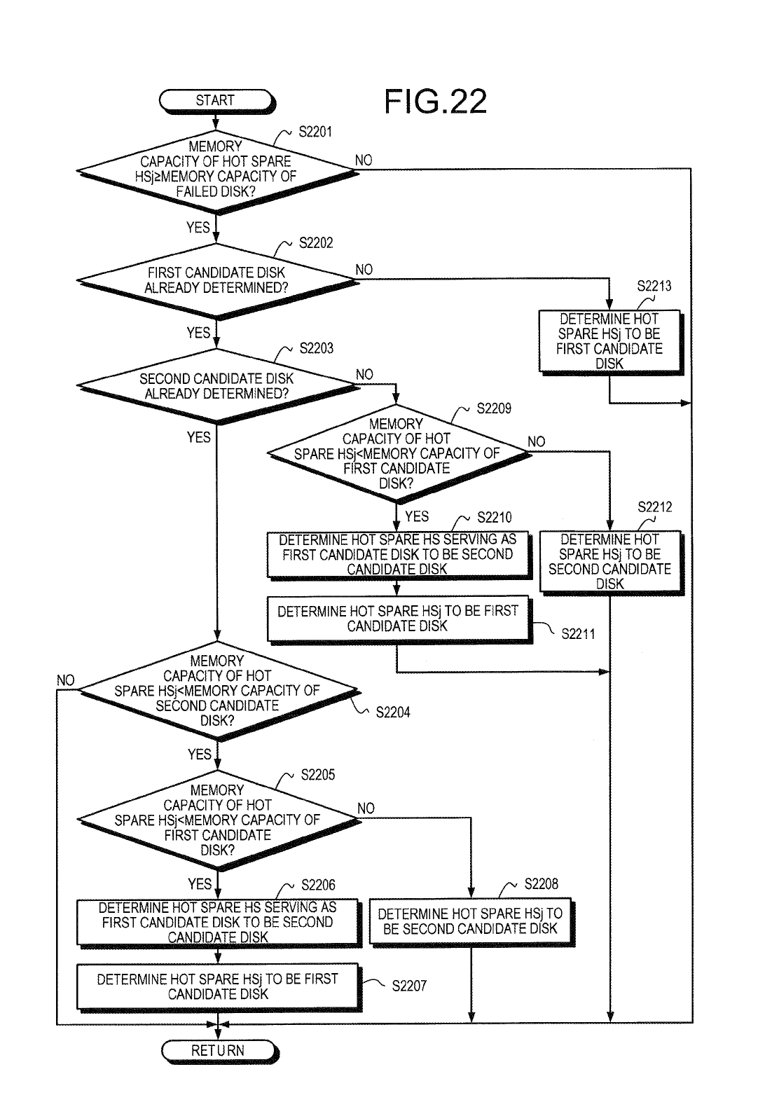

If the hot spare HSj does not satisfy the first search condition (step S1610: NO), the storage controller 101 proceeds to step S1612. If the hot spare HSj satisfies the first search condition (step S1610: YES), the storage controller 101 executes a retrieving process B (step S1611). A procedure of the retrieving process B will be described later with reference to FIG. 22.

The storage controller 101 increments the value of “j” of the hot spare HSj by 1 (step S1612), and determines whether “j” is greater than “m” (step S1613). If “j” is less than or equal to “m” (step S1613: NO), the storage controller 101 returns to step S1609.

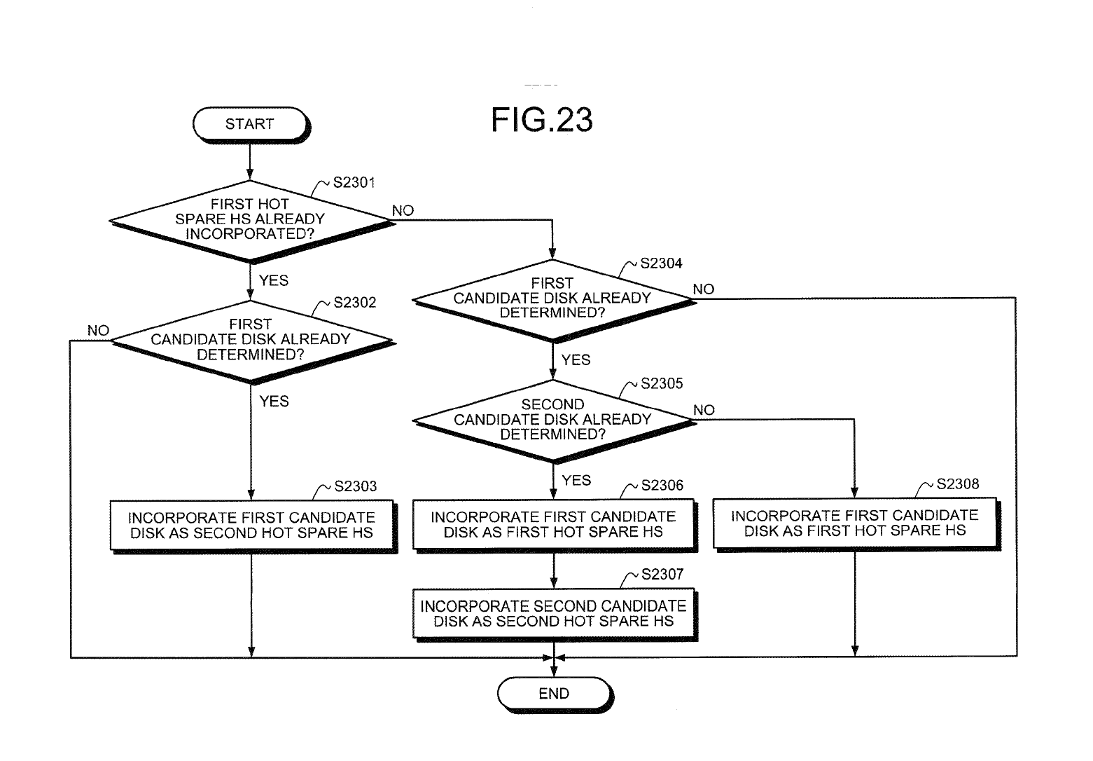

If “j” is greater than “m” (step S1613: YES), the storage controller 101 executes an assigning process of incorporating a hot spare HS into the RAID group G (step S1614). A procedure of the assigning process will be described later with reference to FIG. 23.

The storage controller 101 determines whether the second hot spare HS is already incorporated in the RAID group G (step S1615). If the second hot spare HS is already incorporated in the RAID group G (step S1615: YES), the storage controller 101 ends the series of operations according to the flowchart, and returns to the step at which the hot spare retrieving process is called.

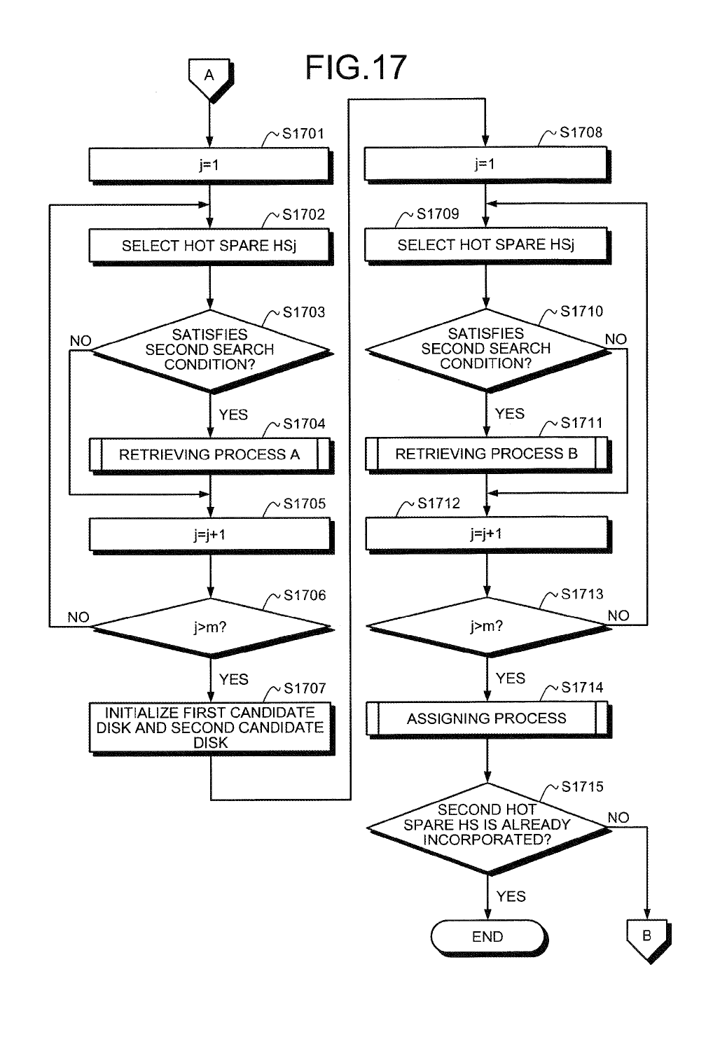

If the second hot spare HS is not already incorporated in the RAID group G (step S1615: NO), the storage controller 101 proceeds to step S1701 of FIG. 17.

In the flowchart of FIG. 17, the storage controller 101 sets “j” of a hot spare HSj to “j=1” (step S1701), and selects the hot spare HSj from among hot spares HS1 to HSm (step S1702).

The storage controller 101 determines whether the selected hot spare HSj satisfies the second search condition (step S1703). A hot spare HS satisfying the second search condition is an unused hot spare HS defined by (b) described above.

If the hot spare HSj does not satisfy the second search condition (step S1703: NO), the storage controller 101 proceeds to step S1705. If the hot spare HSj satisfies the second search condition (step S1703: YES), the storage controller 101 executes the retrieving process A (step S1704).

The storage controller 101 increments the value of “j” of the hot spare HSj by 1 (step S1705), and determines whether “j” is greater than “m” (step S1706). If “j” is less than or equal to “m” (step S1706: NO), the storage controller 101 returns to step S1702.

If “j” is greater than “m” (step S1706: YES), the storage controller 101 initializes the first candidate disk and the second candidate disk (step S1707).

The storage controller 101 sets “j” of the hot spare HSj to “j=1” (step S1708), and selects the hot spare HSj from among the hot spares HS1 to HSm (step S1709). The storage controller 101 determines whether the selected hot spare HSj satisfies the second search condition (step S1710).

If the hot spare HSj does not satisfy the second search condition (step S1710: NO), the storage controller 101 proceeds to step S1712. If the hot spare HSj satisfies the second search condition (step S1710: YES), the storage controller 101 executes the retrieving process B (step S1711).

The storage controller 101 increments the value of “j” of the hot spare HSj by 1 (step S1712), and determines whether “j” is greater than “m” (step S1713). If “j” is less than or equal to “m” (step S1713: NO), the storage controller 101 returns to step S1709.

If “j” is greater than “m” (step S1713: YES), the storage controller 101 executes the assigning process of incorporating a hot spare HS into the RAID group G (step S1714).

The storage controller 101 determines whether the second hot spare HS is already incorporated in the RAID group G (step S1715). If the second hot spare HS is already incorporated in the RAID group G (step S1715: YES), the storage controller 101 ends the series of operations according to the flowchart, and returns to the step at which the hot spare retrieving process is called.

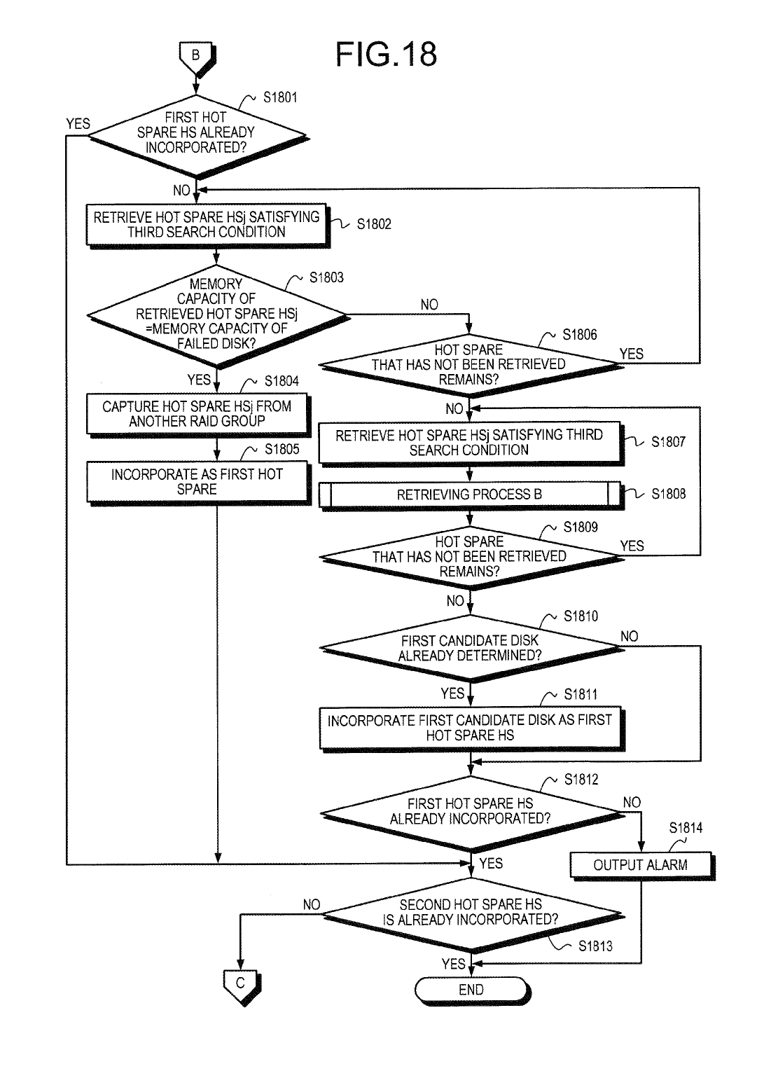

If the second hot spare HS is not already incorporated in the RAID group G (step S1715: NO), the storage controller 101 proceeds to step S1801 of FIG. 18.

In the flowchart of FIG. 18, the storage controller 101 determines whether the first hot spare HS is already incorporated in the RAID group G (step S1801). If the first hot spare HS is already incorporated in the RAID group G (step S1801: YES), the storage controller 101 proceeds to step S1813.

If the first hot spare HS is not already incorporated in the RAID group G (step S1810: NO), the storage controller 101 searches the hot spares HS1 to HSm to retrieve a hot spare HSj satisfying the third search condition (step S1802). A hot spare HS satisfying the third search condition is a hot spare HS defined by (c) described above.

The storage controller 101 determines whether the memory capacity of the retrieved hot spare HSj is the same as the memory capacity of the failed disk in the RAID group G (step S1803). If the memory capacity of the hot spare HSj is the same as the memory capacity of the failed disk (step S1803: YES), the storage controller 101 captures a hot spare HSj from another RAID group G (step S1804).

The storage controller 101 incorporates the captured hot spare HSj into the RAID group G, as the first hot spare (step S1805), and proceeds to step S1813.

If the memory capacity of the hot spare HSj is not the same as the memory capacity of the failed disk at step S1803 (step S1803: NO), the storage controller 101 determines whether a hot spare that has not been retrieved at step S1802 remains (step S1806).

If non-retrieved hot spares remain (step S1806: YES), the storage controller 101 returns to step S1802, and searches the hot spares HS1 to HSm to retrieve a hot spare HSj satisfying the third search condition.

If no hot spares remain (step S1806: NO), the storage controller 101 searches the hot spares HS1 to HSm to retrieve a hot spare HSj satisfying the third search condition (step S1807). The storage controller 101 executes the retrieving process B (step S1808).

The storage controller 101 determines whether hot spares not retrieved at step S1807 remain (step S1809). If non-retrieved hot spares remain (step S1809: YES), the storage controller 101 returns to step S1807, and searches the hot spares HS1 to HSm to retrieve a hot spare HSj satisfying the third search condition.

If hot spares no remain (step S1809: NO), the storage controller 101 determines whether the first candidate disk is already determined (step S1810). If the first candidate disk is not already determined (step S1810: NO), the storage controller 101 proceeds to step S1812.

If the first candidate disk is already determined (step S1810: YES), the storage controller 101 incorporates the first candidate disk into the RAID group G, as the first hot spare HS (step S1811). The storage controller 101 determines whether the first hot spare HS is already incorporated in the RAID group G (step S1812).

If the first hot spare HS is already incorporated in the RAID group G (step S1812: YES), the storage controller 101 determines whether the second hot spare HS is already incorporated in the RAID group G (step S1813). If the second hot spare HS is already incorporated in the RAID group G (step S1813: YES), the storage controller 101 ends the series of operations according to the flowchart, and returns to the step at which the hot spare retrieving process is called.

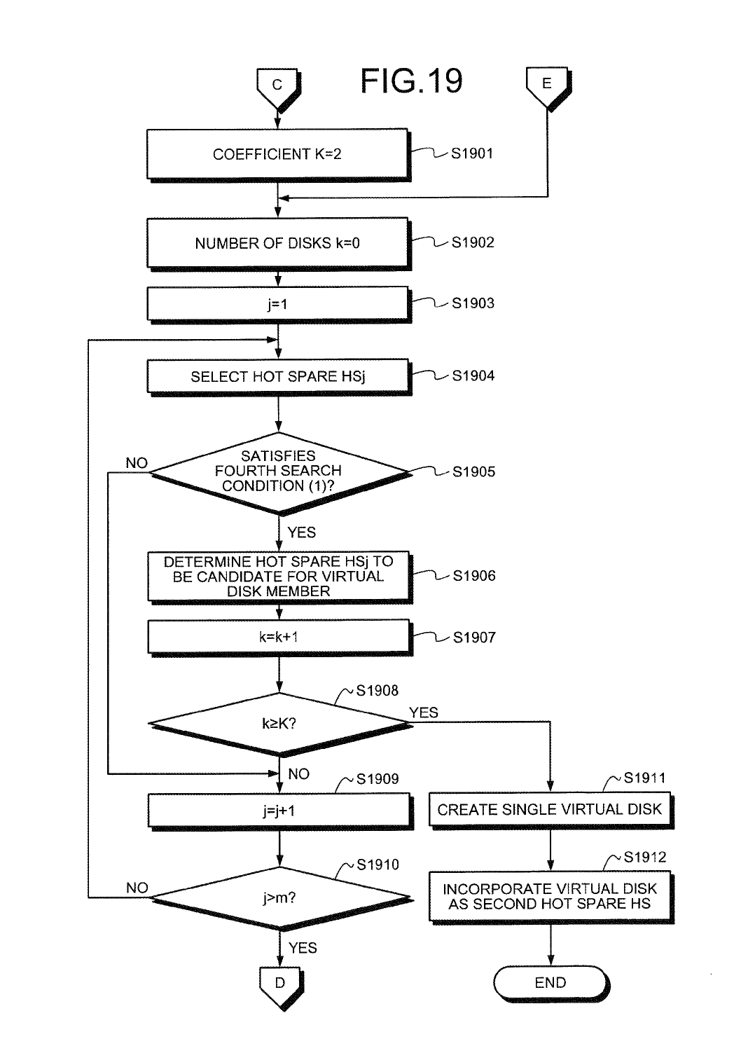

If the second hot spare HS is not already incorporated in the RAID group G (step S1813: NO), the storage controller 101 proceeds to step S1901 of FIG. 19.

If the first hot spare HS is not already incorporated in the RAID group G at step S1812 (step S1812: NO), the storage controller 101 outputs an alarm indicating that the rebuilding process is not possible (step S1814), and ends the series of operations.

In the flowchart of FIG. 19, the storage controller 101 sets the coefficient “K” to “K=2” (step S1901) and sets the number of disks “k” to “k=0” (step S1902). The storage controller 101 then sets “j” of the hot spare HSj to “j=1” (step S1903), and selects the hot spare HSj from among the hot spares HS1 to HSm (step S1904).

The storage controller 101 determines whether the selected hot spare HSj satisfies the fourth search condition (1) (step S1905). A hot spare HS satisfying the fourth search condition (1) is a hot spare HS defined by (iii) or (iv) described above.

If the hot spare HSj does not satisfy the fourth search condition (1) (step S1905: NO), the storage controller 101 proceeds to step S1909. If the hot spare HSj satisfies the fourth search condition (1) (step S1905: YES), the storage controller 101 determines the hot spare HSj to be a candidate for a virtual disk member (step S1906).

The storage controller 101 increases the value of the number of disks “k” by 1 (step S1907), and determines if “k” is greater than or equal to “K” (step S1908). If “k” is less than “K” (step S1908: NO), the storage controller 101 increases the value of “j” of the hot spare HSj by 1 (step S1909), and determines whether “j” has become larger than “m” (step S1910).

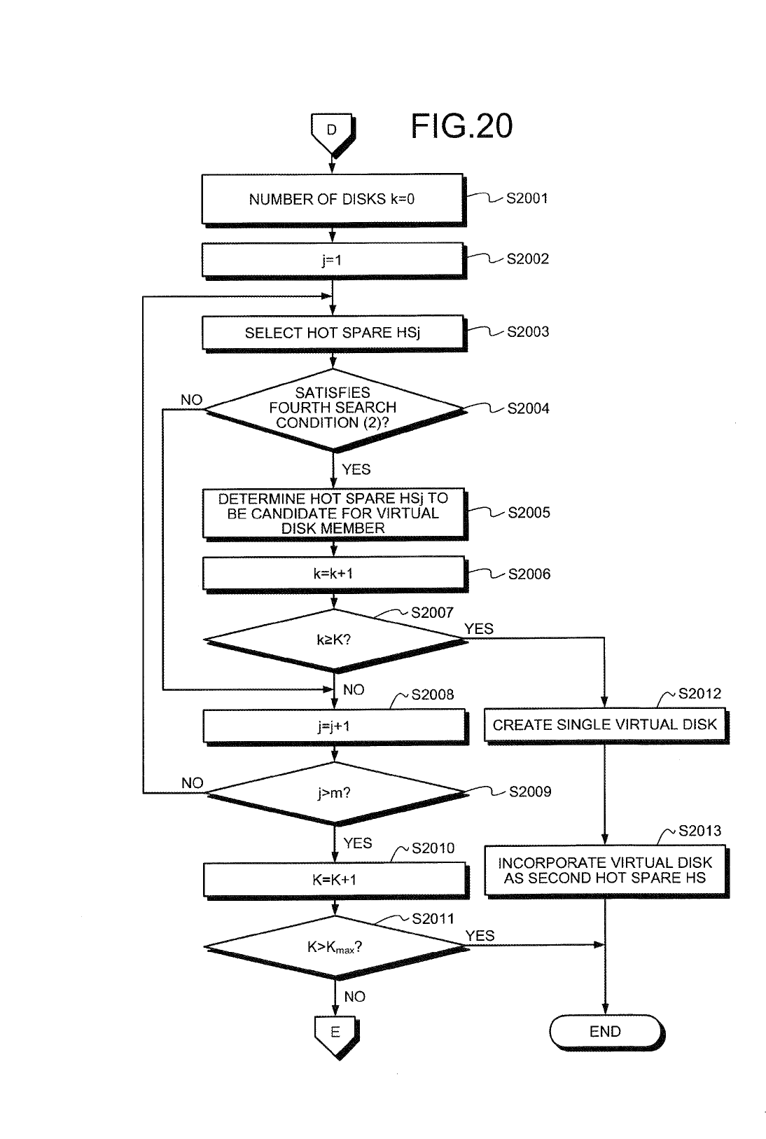

If “j” is less than or equal to “m” (step S1910: NO), the storage controller 101 returns to step S1904. W If “j” is greater than “m” (step S1910: YES), the storage controller 101 proceeds to step S2001 of FIG. 20.

If “k” is greater than or equal to “K” at step S1908 (step S1908: YES), the storage controller 101 creates a single virtual disk using K hot spares HS determined to be virtual disk member candidates (step S1911).

The storage controller 101 incorporates the created virtual disk into the RAID group G, as the second hot spare HS (step S1912), ends the series of operations according to the flowchart, and returns to the step at which the hot spare retrieving process is called.

In the flowchart of FIG. 20, the storage controller 101 sets the number of disks “k” to “k=0” (step S2001). The storage controller 101 sets “j” of the hot spare HSj to “j=1” (step S2002), and selects the hot spare HSj from among the hot spares HS1 to HSm (step S2003).

The storage controller 101 determines whether the selected hot spare HSj satisfies the fourth search condition (2) (step S2004). A hot spare HS satisfying the fourth search condition (2) is a hot spare HS defined by (v) among unused hot spares HS defined by (d) described above.

If the hot spare HSj does not satisfy the fourth search condition (2) (step S2004: NO), the storage controller 101 proceeds to step S2008. If the hot spare HSj satisfies the fourth search condition (2) (step S2004: YES), the storage controller 101 determines the hot spare HSj to be a candidate for the virtual disk member (step S2005).

The storage controller 101 increases the value of the number of disks “k” by 1 (step S2006), and determines if “k” is greater than or equal to “K” (step S2007). If “k” is less than “K” (step S2007: NO), the storage controller 101 increases the value of “j” of the hot spare HSj by 1 (step S2008), and determines whether “j” is greater than “m” (step S2009).

If “j” is less than or equal to “m” (step S2009: NO), the storage controller 101 returns to step S2003. If “j” is greater than “m” (step S2009: YES), the storage controller 101 increases the value of the coefficient “K” by 1 (step S2010).

The storage controller 101 determines whether “K” is greater than “Kₘₐₓ” (step S2011). Kₘₐₓ represents the upper limit of the coefficient K, and is stored as a preset value, for example, in the memory 402.

If “K” is less than or equal to “Kmax” (step S2011: NO), the storage controller 101 returns to step S1902 of FIG. 19. If “K” is greater than “Kₘₐₓ” (step S2011: YES), the storage controller 101 ends the series of operations according to the flowchart and returns to the step at which the hot spare retrieving process is called.

If “k” is greater than or equal to “K” at step S2007 (step S2007: YES), the storage controller 101 creates a single virtual disk using K hot spares HS determined to be virtual disk member candidates (step S2012).

The storage controller 101 incorporates the created virtual disk into the RAID group G, as the second hot spare HS (step S2013), ends the series of operations according to the flowchart, and returns to the step at which the hot spare retrieving process is called.

In this manner, the first and second hot spares HS to be incorporated into the RAID group G as substitute disks for the failed disk may be retrieved.

A procedure of the retrieving process A at step S1604 of FIG. 16 and step S1704 of FIG. 17 will be described.

FIG. 21 is a flowchart of an example of a specific procedure of the retrieving process A. In the flowchart of FIG. 21, the storage controller 101 determines whether the memory capacity of the hot spare HSj is the same as the memory capacity of the failed disk in the RAID group G (step S2101).

If the memory capacity of the hot spare HSj is the same as the memory capacity of the failed disk (step S2101: YES), the storage controller 101 determines whether the first hot spare HS is already incorporated in the RAID group G (step S2102).

If the first hot spare HS is already incorporated in the RAID group G (step S2102: YES), the storage controller 101 incorporates the hot spare HSj into the RAID group G, as the second hot spare HS (step S2103), ends a series of operations according to the flowchart, and returns to the step at which the hot spare retrieving process is called.

If the first hot spare HS is not already incorporated in the RAID group G (step S2102: NO), the storage controller 101 incorporates the hot spare HSj into the RAID group G, as the first hot spare HS (step S2104), ends the series of operations according to the flowchart, and returns to the step at which the retrieving process A is called.

If the memory capacity of the hot spare HSj is not the same as the memory capacity of the failed disk at step S2101 (step S2101: NO), the storage controller 101 ends the series of operations according to the flowchart, and returns to the step at which the retrieving process A is called.

A procedure of the retrieving process B at step S1611 of FIG. 16, step S1711 of FIG. 17, and step S1808 of FIG. 18 will be described.

FIG. 22 is a flowchart of an example of a procedure of the retrieving process B. In the flowchart of FIG. 22, the storage controller 101 determines if the memory capacity of the hot spare HSj is greater than or equal to the memory capacity of the failed disk in the RAID group G (step S2201).

If the memory capacity of the hot spare HSj is greater than or equal to the memory capacity of the failed disk (step S2201: YES), the storage controller 101 determines whether the first candidate disk is already determined (step S2202). If the first candidate disk is already determined (step S2202: YES), the storage controller 101 determines whether the second candidate disk is already determined (step S2203).

If the second candidate disk is already determined (step S2203: YES), the storage controller 101 determines whether the memory capacity of the hot spare HSj is less than the memory capacity of the second candidate disk (step S2204). If the memory capacity of the hot spare HSj is less than the memory capacity of the second candidate disk (step S2204: YES), the storage controller 101 determines whether the memory capacity of the hot spare HSj is less than the memory capacity of the first candidate disk (step S2205).

If the memory capacity of the hot spare HSj is less than the memory capacity of the first candidate disk (step S2205: YES), the storage controller 101 determines the hot spare HS serving as the first candidate disk to be the second candidate disk (step S2206). The storage controller 101 determines the hot spare HSj to be the first candidate disk (step S2207), ends the series of operations according to the flowchart, and returns to the step at which the retrieving process B is called.

If the memory capacity of the hot spare HSj is greater than or equal to the memory capacity of the first candidate disk at step S2205 (step S2205: NO), the storage controller 101 determines the hot spare HSj to be the second candidate disk (step S2208), ends the series of operations according to the flowchart, and returns to the step at which the retrieving process B is called.

If the memory capacity of the hot spare HSj is greater than or equal to the memory capacity of the second candidate disk at step S2204 (step S2204: NO), the storage controller 101 ends the series of operations according to the flowchart, and returns to the step at which the retrieving process B is called.

If the second candidate disk is not already determined at step S2203 (step S2203: NO), the storage controller 101 determines whether the memory capacity of the hot spare HSj is less than the memory capacity of the first candidate disk (step S2209).

If the memory capacity of the hot spare HSj is less than the memory capacity of the first candidate disk (step S2209: YES), the storage controller 101 determines the hot spare HS serving as the first candidate disk to be the second candidate disk (step S2210). The storage controller 101 determines the hot spare HSj to be the first candidate disk (step S2211), ends the series of operations according to the flowchart, and returns to the step at which the retrieving process B is called.

If the memory contents of the hot spare HSj is greater than or equal to the memory contents of the first candidate disk (step S2209: NO), the storage controller 101 determines the hot spare HSj to be the second candidate disk (step S2212), ends the series of operations according to the flowchart, and returns to the step at which the retrieving process B is called.

If the first candidate disk is not already determined at step S2202 (step S2202: NO), the storage controller 101 determines the hot spare HSj to be the first candidate disk (step S2213), ends the series of operations according to the flowchart, and returns to the step at which the retrieving process B is called.

If the memory capacity of the hot spare HSj is less than the memory capacity of the failed disk at step 2201 (step S2201: NO), the storage controller 101 ends the series of operations according to the flowchart, and returns to the step at which the retrieving process B is called.

A procedure of the assigning process at step S1614 of FIG. 16 and step S1714 of FIG. 17 will be described.

FIG. 23 is a flowchart of an example of a procedure of the assigning process. In the flowchart of FIG. 23, the storage controller 101 determines whether the first hot spare HS is already incorporated in the RAID group G (step S2301). If the first hot spare HS is already incorporated in the RAID group G (step S2301: YES), the storage controller 101 determines whether the first candidate disk is already determined (step S2302).

If the first candidate disk is already determined (step S2302: YES), the storage controller 101 incorporates the first candidate disk into the RAID group G, as the second hot spare HS (step S2303), ends the series of operations according to the flowchart, and returns to the step at which the assigning process is called.

If the first candidate disk is not already determined (step S2302: NO), the storage controller 101 ends the series of operations according to the flowchart, and returns to the step at which the assigning process is called.

If the first hot spare HS is not already incorporated in the RAID group G at step S2301 (step S2301: NO), the storage controller 101 determines whether the first candidate disk is already determined (step S2304). If the first candidate disk is already determined (step S2304: YES), the storage controller 101 determines whether the second candidate disk is already determined (step S2305).

If the second candidate disk is already determined (step S2305: YES), the storage controller 101 incorporates the first candidate disk into the RAID group G, as the first hot spare HS (step S2306). The storage controller 101 incorporates the second candidate disk into the RAID group G, as the second hot spare HS (step S2307), ends the series of operations according to the flowchart, and returns to the step at which the assigning process is called.

If the second candidate disk is not already determined at step S2305 (step S2305: NO), the storage controller 101 incorporates the first candidate disk into the RAID group G, as the first hot spare HS (step S2308), ends the series of operations according to the flowchart, and returns to the step at which the assigning process is called.

If the first candidate disk is not already determined at step S2304 (step S2304: NO), the storage controller 101 ends the series of operations according to the flowchart, and returns to the step at which the assigning process is called.

A RAID group configuration rebuilding procedure by the storage controller 101 will be described.

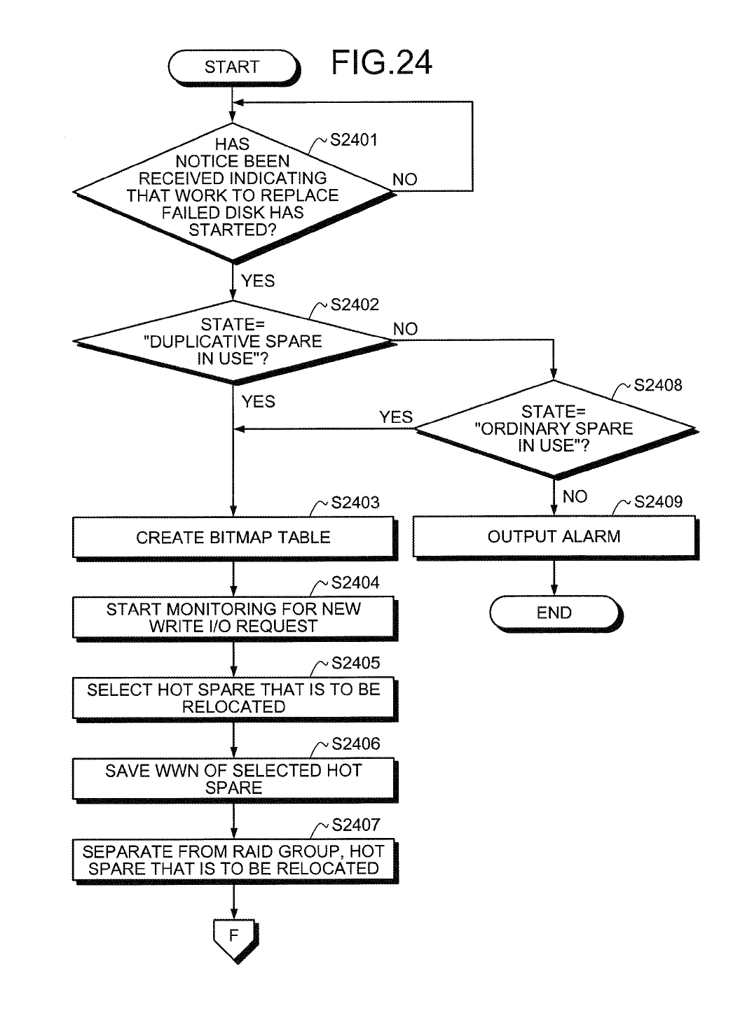

FIGS. 24, 25, 26, and 27 are flowcharts of an example of the RAID group configuration rebuilding procedure by the storage controller 101. In the flowchart of FIG. 24, the storage controller 101 determines whether notice has been received indicating that work to replace a failed disk in the RAID group G has started (step S2401).

The storage controller 101 stands by until receiving notice of the start of work of replacing the failed disk in the RAID group G (step S2401: NO). Upon receiving the notice of the start of work of replacing the failed disk in the RAID group G (step S2401: YES), the storage controller 101 determines whether the state of the RAID group G is “Duplicative Spare in Use” (step S2402).

If the state of the RAID group G is “Duplicative Spare in Use” (step S2402: YES), the storage controller 101 creates the bitmap table 900 for the RAID group G (step S2403). The storage controller 101 starts monitoring to detect a new write I/O request (step S2404).

The storage controller 101 refers to the selection policy 1100 and selects from among the first hot spare HS and/or the second hot spare HS incorporated in the RAID group G, a hot spare that is to be relocated (step S2405). The storage controller 101 saves the WWN of the selected hot spare that is to be relocated (step S2406).

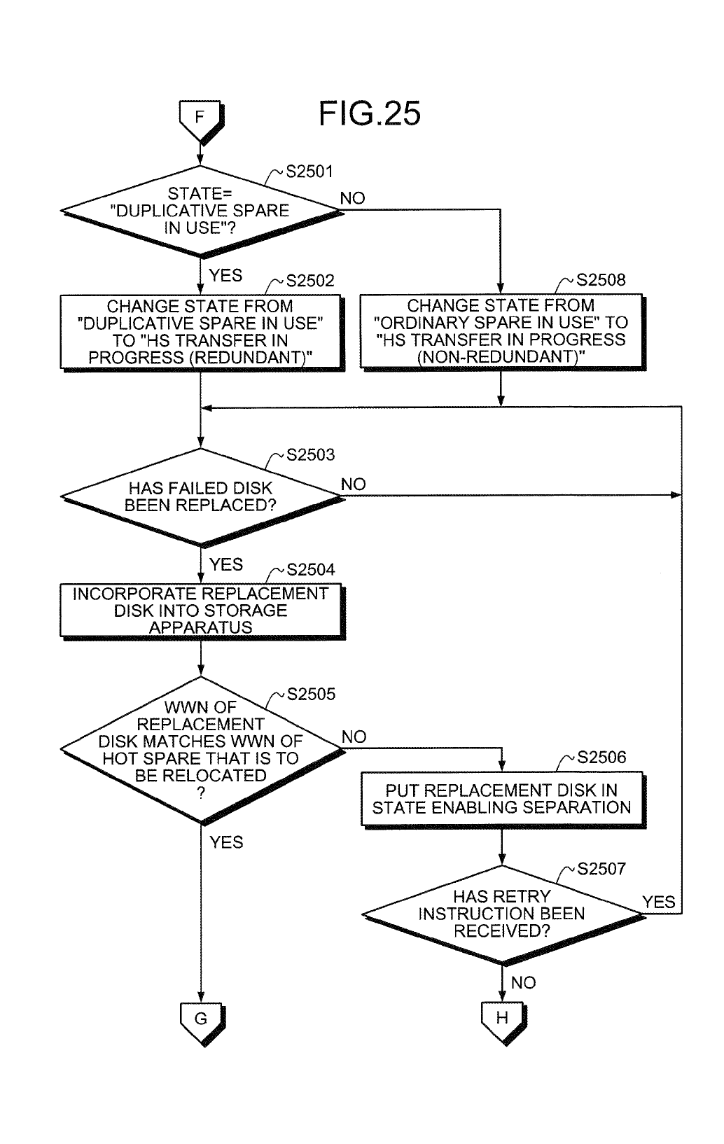

The storage controller 101 separates the hot spare that is to be relocated from the RAID group G to put the hot spare that is to be relocated in a state enabling separation from the storage apparatus 301 (step S2407), and proceeds to step S2501 of FIG. 25.

If the state of the RAID group G is not “Duplicative Spare in Use” at step S2402 (step S2402: NO), the storage controller 101 determines whether the state of the RAID group G is “Ordinary Spare in Use” (step S2408).

If the state of the RAID group G is “Ordinary Spare in Use” (step S2408: YES), the storage controller 101 proceeds to step S2403. If the state of the RAID group G is not “Ordinary Spare in Use” (step S2408: NO), the storage controller 101 outputs an alarm indicating that the relocation operation doesnot be implemented (step S2409), and ends the series of operations according to the flowchart.

In the flowchart of FIG. 25, the storage controller 101 determines whether the state of the RAID group G is “Duplicative Spare in Use” (step S2501). If the state of the RAID group G is “Duplicative Spare in Use” (step S2501: YES), the storage controller 101 changes the state of the RAID group G from “Duplicative Spare in Use” to “HS Transfer in Progress (Redundant)” (step S2502).

The storage controller 101 determines whether the failed disk in the RAID group G has been replaced (step S2503). The storage controller 101 stands by until the failed disk is replaced (step S2503: NO). When the failed disk has been replaced (step S2503: YES), the storage controller 101 incorporates into the storage apparatus 301, the replacement disk that has replaced the failed disk (step S2504).

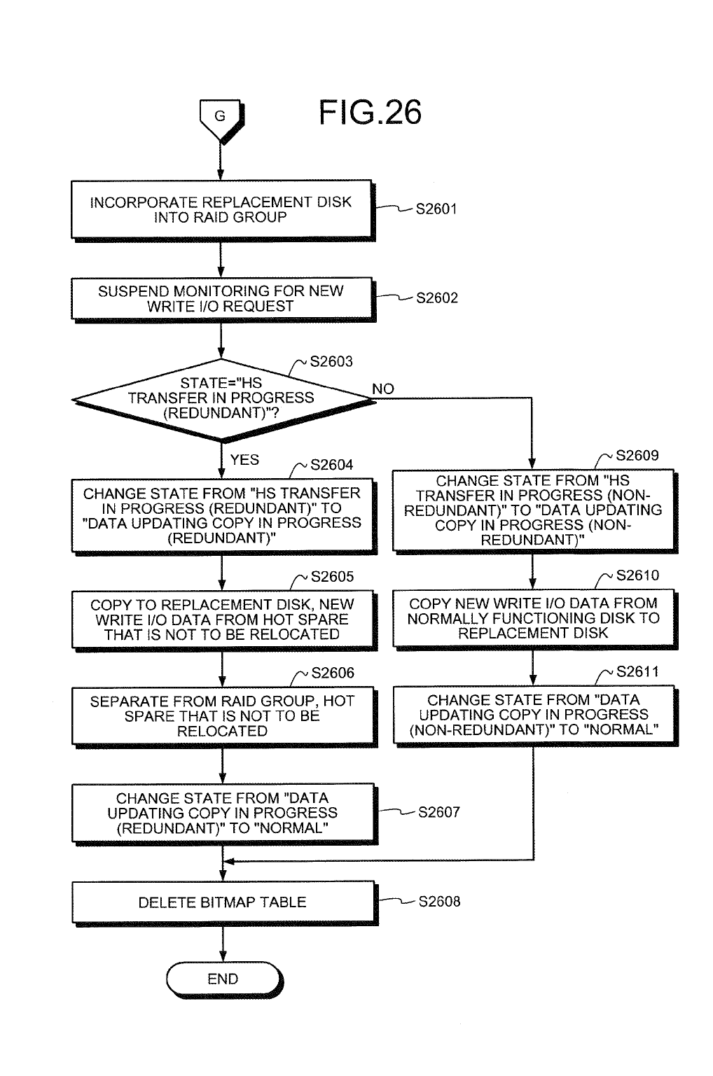

The storage controller 101 determines whether the WWN of the replacement disk matches the WWN of the hot spare that is to be relocated (step S2505). If the WWN of the replacement disk matches the WWN of the hot spare that is to be relocated (step S2505: YES), the storage controller 101 proceeds to step S2601 of FIG. 26.

If the WWN of the replacement disk does not match the WWN of the hot spare that is to be relocated (step S2505: NO), the storage controller 101 puts the replacement disk in a state enabling separation from the storage apparatus 301 (step S2506). The storage controller 101 determines whether a replacement work retry instruction has been received (step S2507).

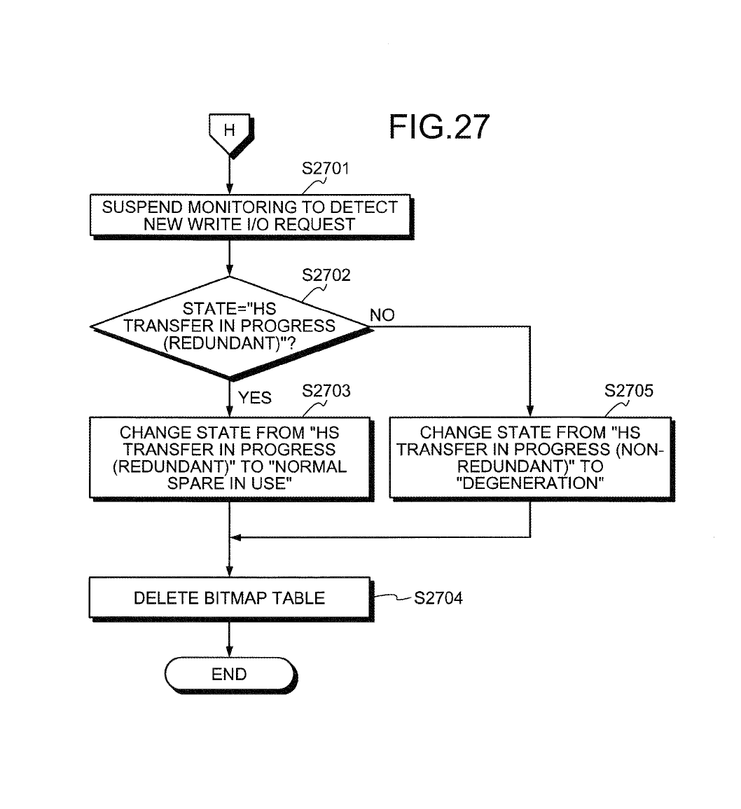

If a replacement work retry instruction has been received (step S2507: YES), the storage controller 101 returns to step S2503. If no replacement work retry instruction has been received (step S2507: NO), the storage controller 101 proceeds to step S2701 of FIG. 27.

If the state of the RAID group G is not “Duplicative Spare in Use” at step S2501 (step S2501: NO), the storage controller 101 changes the state of the RAID group G from “Ordinary Spare in Use” to “HS Transfer in Progress (Non-Redundant)” (step S2508), and proceeds to step S2503.

In the flowchart of FIG. 26, the storage controller 101 incorporates the replacement disk into the RAID group G (step S2601). The storage controller 101 suspends monitoring to detect a new write I/O request (step S2602).

The storage controller 101 determines whether the state of the RAID group G is “HS transfer in Progress (Redundant)” (step S2603). If the state of the RAID group G is “HS transfer in Progress (Redundant)” (step S2603: YES), the storage controller 101 changes the state of the RAID group G from “HS transfer in Progress (Redundant)” to “Data Updating Copy in Progress (Redundant)” (step S2604).

The storage controller 101 refers to the bitmap table 900 and copies new write I/O data from a hot spare that is not to be relocated to the replacement disk, as updated data (data updating process) (step S2605). The storage controller 101 separates the hot spare that is not to be relocated from the RAID group G (step S2606).

The storage controller 101 changes the state of the RAID group G from “Data Updating Copy in Progress (Redundant)” to “Normal” (step S2607). The storage controller 101 deletes the bitmap table 900 for the RAID group G (step S2608), and ends the series of operations according to the flowchart.

If the state of the RAID group G is not “HS Transfer in Progress (Redundant)” at step S2603 (step S2603: NO), the storage controller 101 changes the state of the RAID group G from “HS Transfer in Progress (Non-Redundant)” to “Data Updating Copy in Progress (Non-Redundant)” (step S2609).

The storage controller 101 refers to the bitmap table 900 and copies new write I/O data from a normally functioning disk to the replacement disk, as updated data (data updating process) (step S2610). The storage controller 101 changes the state of the RAID group G from “Data Updating Copy in Progress (Non-Redundant)”to “Normal” (step S2611), and proceeds to step S2608.

In the flowchart of FIG. 27, the storage controller 101 suspends monitoring to detect a new write I/O request (step S2701). The storage controller 101 determines whether the state of the RAID group G is “HS Transfer in Progress (Redundant)” (step S2702).

If the state of the RAID group G is “HS Transfer in Progress (Redundant)” (step S2702: YES), the storage controller 101 changes the state of the RAID group G from “HS Transfer in Progress (Redundant)” to “Normal Spare in Use” (step S2703). The storage controller 101 deletes the bitmap table 900 for the RAID group G (step S2704), and ends the series of operations according to the flowchart.

If the state of the RAID group G is not “HS Transfer in Progress (Redundant)” at step S2702 (step S2702: NO), the storage controller 101 changes the state of the RAID group G from “HS Transfer in Progress (Non-Redundant)” to “Degeneration” (step S2705), and proceeds to step S2704.

In this manner, the memory contents of the replacement disk that has replaced the failed disk is made equivalent to the memory contents of the hot spare that is not to be relocated. Hence, the configuration of the RAID group G is restored to the original configuration before the disk failure.

As described, according to the storage controller 101, if the disk Di in the RAID group G fails, the first and second hot spares may be incorporated into the RAID group G, as substitute storage units for the failed disk. According to the storage controller 101, the memory contents of the failed disk may be restored onto the first and second hot spares incorporated into the RAID group G.

As a result, the redundancy of the RAID group G may be restored using the first and second hot spares incorporated into the RAID group G as the substitute storage units for the failed disk.

According to the storage controller 101, writing destination information indicating a writing destination for writing data written to the hot spare that is not to be relocated may be saved during failed disk replacement work. Thus, the writing destination for the writing data written to the hot spare that is not to be relocated may be identified during the failed disk replacement work.

According to the storage controller 101, the writing destination for the writing data written to the hot spare that is not to be relocated during the failed disk replacement work may be managed using the bitmap table 900. This reduces the amount of the memory 402 used for saving writing destination information indicating the writing destination for writing data.

According to the storage controller 101, when a notice of the start of failed disk replacement work is received, the hot spare that is to be relocated may be separated from the RAID group G to put the hot spare that is to be relocated in a state enabling separation from the storage apparatus 301. According to the storage controller 101, when the failed disk in the RAID group G is replaced with the replacement disk, the replacement disk may be incorporated into the RAID group G. Hence, the configuration of the RAID group G is restored to the original configuration before the disk failure.

According to the storage controller 101, when incorporation of the replacement disk into the RAID group G is completed, writing data stored in the hot spare that is not to be relocated may be written to the replacement disk, by referring to writing destination information. Through this process, the memory contents of the hot spare that is to be relocated may be made equivalent to the memory contents of the hot spare that is not to be relocated.

According to the storage controller 101, when writing of writing data to the replacement disk is completed, the hot spare that is not to be relocated may be separated from the RAID group G. Hence, the hot spare that is not to be relocated incorporated in the RAID group G is released from the RAID group G, and may be used as a substitute storage unit.

According to the storage controller 101, when the hot spare that is not to be relocated is separated from the RAID group G, the bitmap table 900 for the RAID group G may be deleted from the memory 402. In this manner, the bitmap table 900 for the RAID group G restored to the original state before the occurrence of the disk failure is deleted from the memory 402 to reduce the amount of the memory 402 used.

According to the storage controller 101, if the WWN of the replacement disk matches the WWN of the hot spare that is to be relocated, the replacement disk may be incorporated into the RAID group G. The hot spare that is to be relocated is provided as the replacement disk, therefore, the replacement disk may be incorporated into the RAID group G. This prevents a case where a disk not storing the restored memory contents of the failed disk is incorporated into the RAID group G.

According to the storage controller 101, the first hot spare and the second hot spare may be retrieved based on the memory capacity of each of the first and second hot spares and on the memory capacity of the failed disk. Therefore, a hot spare having a memory capacity greater than or equal to the memory capacity of the failed disk may be retrieved respectively as the first and second hot spares. This prevents a case where the memory capacity of the failed disk doesnot be restored.

According to the storage controller 101, the first hot spare and the second hot spare may be retrieved based on installation location information of the failed disk and of a normally functioning disk. Therefore, the first hot spare and the second hot spare may be retrieved so that storage units ST in the RAID group G are not housed in the same enclosure or connected to the same back end loop in a biased configuration. This reduces the risk that the breakdown of an enclosure brings the RAID group G into a state of failure.

According to the storage controller 101, a virtual disk may be made as either the first hot spare or the second hot spare, using unused hot spares not used as a substitute disk. When the second hot spare to be incorporated into the RAID group G doesnot be prepared, a virtual disk made by combining together multiple hot spares each having a memory capacity smaller than the memory capacity of the failed disk may be incorporated into the RAID group G, as the second hot spare.

According to the storage controller 101, one of two hot spares HS incorporated in another RAID group G may be captured and incorporated into the RAID group G. If a hot spare HS to be incorporated into the RAID group G doesnot be prepared, one hot spare HS is captured from another RAID group G and is used to restore the redundancy of the RAID group G.

According to the storage apparatus 301 of the embodiments, therefore, when the disk Di in the RAID group G fails, the redundancy of the RAID group G is restored and the configuration of the RAID group G is restored to the original configuration before the occurrence of the failure. The processing time required for a restoring process for restoring the configuration of the RAID group G to the original configuration before the failure of a storage unit ST may be reduced, compared to the conventional copy back process. Hence, decreases in the response to an I/O request from the host 302 may be suppressed.

The storage control method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According to aspect of the present embodiments, the processing time required for data restoration when a failure of storage occurs is reduced.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage apparatus comprising:
a plurality of storage units belonging to a redundantly configured storage unit group;
a first storage unit and a second storage unit independent of the storage unit group;
a configuration control unit that incorporates at least any one among the first storage unit and the second storage unit into the storage unit group or separates at least any one among the first storage unit and the second storage unit from the storage unit group; and
a restoring unit that when a storage unit in the storage unit group fails, restores memory contents of the failed storage unit onto the first storage unit and second storage unit incorporated into the storage unit group by the configuration control unit, based on memory contents of the storage units other than the failed storage unit and belonging to the storage unit group, wherein
the configuration control unit without separating the second storage unit, separates the first storage unit from the storage unit group after the restoring unit restores the memory contents, and when the failed storage unit has been replaced with the first storage unit, incorporates the first storage unit into the storage unit group, as a replacement storage unit.

2. The storage apparatus according to claim 1, comprising:
a memory unit that stores therein during a period between separation of the first storage unit from the storage unit group and incorporation of the replacement storage unit into the storage unit group, writing destination information indicating a writing destination to which data written to the second storage unit is written; and
an updating unit that when incorporation of the replacement storage unit into the storage unit group is completed, refers to the writing destination information stored in the memory unit and writes the data stored in the second storage unit to the replacement storage unit.

3. The storage apparatus according to claim 2, wherein
the configuration control unit separates the second storage unit from the storage unit group, when the updating unit has finished writing the data to the replacement storage unit.

4. The storage apparatus according to claim 1, comprising
a determining unit that when the failed storage unit has been replaced with the replacement storage unit, determines whether identification information of the replacement storage unit matches identification information of the first storage unit; wherein
the configuration control unit incorporates the replacement storage unit into the storage unit group, when the determining unit determines that the identification information of the replacement storage unit matches the identification information of the first storage unit.

5. The storage apparatus according to claim 1, comprising
a retrieving unit that searches the storage units to retrieve the first storage unit and the second storage unit, based on a memory capacity of the failed storage unit and memory capacities of storage units that may be used as substitute storage units and are equipped in the storage apparatus, wherein
the configuration control unit incorporates into the storage unit group, the first storage unit and second storage unit retrieved by the retrieving unit.

6. The storage apparatus according to claim 5, comprising
a creating unit that when the retrieving unit does not retrieve the second storage unit, creates a virtual storage unit having a memory capacity greater than or equal to the memory capacity of the failed storage unit, using unused storage units among the storage units, the unused storage units being not used as the substitute storage units, wherein
the configuration control unit incorporates into the storage unit group, the first storage unit retrieved by the retrieving unit, and incorporates into the storage unit group, as the second storage unit, the virtual storage created by the creating unit.

7. The storage apparatus according to claim 5, wherein
the retrieving unit searches the storage units to retrieve the first storage unit and the second storage unit, based on an installation location of the failed storage unit.

8. The storage apparatus according to claim 5, wherein
the retrieving unit searches the storage units to retrieve the first storage unit and the second storage unit, based on an installation location of the storage units other than the failed storage unit.

9. The storage apparatus according to claim 1, comprising a writing unit that when a request for writing data to the failed storage unit is made during data restoring by the restoring unit, writes the data to the first storage unit and the second storage unit.

10. The storage apparatus according to claim 9, wherein
the writing unit writes the data to the second storage unit, when a request for writing data to the failed storage unit is made during a period between separation of the first storage unit from the storage unit group and incorporation of the replacement storage unit into the storage unit group.

11. The storage apparatus according to claim 3, comprising a deleting unit that when the second storage unit has been separated from the storage unit group, deletes the writing destination information stored in the memory unit.

12. A computer-readable recording medium storing a storage control program causing a computer to execute a process comprising:
incorporating into a redundantly configured storage unit group when a storage unit belonging to the storage unit group fails, a first storage unit and a second storage unit that are independent of the storage unit group;
restoring when the storage unit in the storage unit group fails, memory contents of the failed storage unit onto the incorporated first storage unit and the second storage unit, based on memory contents of storage units other than the failed storage unit and belonging to the storage unit group; and
separating from the storage unit group after the memory contents are restored, the first storage unit without separating the second storage unit, and incorporating the first storage unit into the storage unit group, as a replacement storage unit when the failed storage unit has been replaced with the first storage unit.

13. A storage control method executed by a computer, the storage control method comprising:
incorporating into a redundantly configured storage unit group when a storage unit belonging to the storage unit group fails, a first storage unit and a second storage unit that are independent of the storage unit group;
restoring when the storage unit in the storage unit group fails, memory contents of the failed storage unit onto the incorporated first storage unit and the second storage unit, based on memory contents of storage units other than the failed storage unit and belonging to the storage unit group; and
separating from the storage unit group after the memory contents are restored, the first storage unit without separating the second storage unit, and incorporating the first storage unit into the storage unit group, as a replacement storage unit when the failed storage unit has been replaced with the first storage unit.
